(19) United States
(12) Patent Application Publication
(10) Pub. No.: US 2026/0105490 A1
(43) Pub. Date: Apr. 16, 2026

(54) INTERACTIVE EPISODIC ADVERTISEMENTS

(71) Applicant: Zynga Inc., San Francisco, CA (US)

(72) Inventor: Luke Dicken, San Francisco, CA (US)

(21) Appl. No.: 18/915,047

(22) Filed: Oct. 14, 2024

(51) Int. Cl. G06Q 30/0251

(52) U.S. Cl. CPC G06Q 30/0271; G06Q 30/0257; G06Q 30/0264

(57) ABSTRACT

This disclosure relates to computer-implemented methods and systems for delivering engaging advertising campaigns composed of episodic advertisements. Each episodic advertisement represents a segment of a larger campaign progression, defined by multiple episodic advertisements presented in sequence. These advertisements are customized based on previous user interactions, enabling engaging storylines that respond to user choices. The system stores, manages, and dynamically selects subsequent episodes based on these interactions, employing storyline templates to serve interactive advertisements across multiple impressions.

### BACKGROUND

This disclosure relates to systems and methods for providing engaging and interactive advertisements to users. Traditional advertisements often fail to fully capture user attention and interest. The landscape of digital advertising has undergone significant transformations over the past few decades. Initially, digital ads were simple, static banners displayed on websites, offering limited engagement and often perceived as intrusive by users. As the internet evolved, so did the complexity and sophistication of advertising strategies, aiming to capture user attention and drive higher conversion rates.

One of the primary challenges in the current state of digital advertising is user engagement. With the proliferation of online content and the subsequent rise in ad exposure, users have developed banner blindness, a phenomenon where they consciously or subconsciously ignore ad content. This has led to decreased click-through rates (CTRs) and overall ad effectiveness, prompting advertisers to seek innovative ways to engage users.

The effectiveness of traditional ad formats has been further challenged by the shift in consumer behavior towards mobile usage and the expectation for more personalized and relevant ad experiences. Traditional ads, often designed for desktop consumption, do not translate well to the smaller screens and varied contexts of mobile devices. Additionally, the one-size-fits-all approach fails to consider individual users'diverse interests and behaviors, leading to lower engagement levels.

Interactivity in advertising has emerged as a potential solution to these challenges. Interactive ads, which require user participation and offer a more dynamic experience, have shown promise in increasing user engagement. These ads can take various forms, such as games, quizzes, or interactive videos, and are designed to provide value beyond the advertisement itself, thereby fostering a more positive user experience.

Despite the potential of interactive ads, there are limitations to the existing ad technologies. Creating interactive content can be resource-intensive, requiring more sophisticated design and development efforts. Additionally, the integration of interactivity often necessitates advanced tracking and data analysis capabilities to effectively tailor experiences to individual users. Advertisers must also navigate the delicate balance between providing engaging content and respecting user privacy and data protection regulations.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 illustrates a network environment for an episodic ad campaign system according to one example in which game-related ad campaigns are provided for a computer-implemented game.

FIG. 2 is a schematic diagram illustrating an example architecture and data flow of an ad campaign system consistent with or analogous to the example implementation of FIG. 1.

FIG. 3 is a high-level flow diagram illustrating a method for providing interactive advertising content to a target user, in some example embodiments.

FIG. 4 is a more detailed flow diagram illustrating a method for providing an episodic ad campaign for game-related content, implemented by systems consistent with or analogous to those of FIG. 1 and FIG. 2.

FIG. 5 illustrates a set of UI screenshots of an example playable interactive advertisement, according to an example consistent with the method of FIG. 4.

FIG. 6 is a flow diagram illustrating a method for initiating direct play of a computer-implemented game based at least in part on campaign state data from an episodic ad campaign for the game, according to one example.

FIG. 7 is a diagrammatic representation of a networked environment in which the present disclosure may be deployed, in accordance with some examples.

FIG. 8 is a block diagram showing a software architecture within which the present disclosure may be implemented, according to some examples.

FIG. 9 is a diagrammatic representation of a machine in the form of a computer system within which a set of instructions may be executed for causing the machine to perform any one or more of the methodologies discussed herein, in accordance with some examples.

### DETAILED DESCRIPTION

### OVERVIEW

One aspect of this disclosure provides for computer-implemented methods and systems for delivering an advertising campaign composed of a set of episodic advertisements. Each episodic advertisement is a segment of a campaign progression defined by multiple episodic advertisements presented in sequence. The advertisements are customized based on previous interactions by the user, allowing for engaging storylines that respond to user choices. Example systems store and manage these episodic advertisements, track user interactions, and dynamically select subsequent episodes based on those interactions. A storyline advertisement system in accordance with the disclosure in some examples selects and parameterizes storyline templates to serve interactive advertisements to users across multiple impressions.

In example implementations, a user is served an interactive advertisement impression with a prompt for user interaction, for example providing a narrative segment presenting a choice of narrative arc by providing two or more alternative user response options, with resultant user input indicating user choice of a particular storyline or narrative arc and/or other interaction choices within the storyline segment. These choices are stored to the user's interaction history. In a later advertising opportunity, the system retrieves this history and selects a next narrative segment to serve to the user based on their previous interactions. The new narrative segment references the user's past choices, for example in a manner in which they have impacted the state of the story's world. The user is presented with new choices, continuing their unique storyline.

Example methods thus include storing an advertising campaign and, in response to a request for an advertisement, retrieving and presenting a first episodic advertisement to a user device. User interaction with this advertisement is received and processed. Upon a subsequent request for an advertisement, a second episodic advertisement is selected from the campaign, with the selection being variable as a function of the user interaction with the first episodic advertisement. This second advertisement is then presented to the user device. Note in this respect that the terms first and second episodic advertisement are used to disambiguate two episodic advertisements spaced in sequence in the same advertising campaign and do not necessarily indicate that the first episodic ad is an initial advertisement served in the campaign or that said second episodic advertisement is immediately subsequent to said first episodic advertisement in a user-experience sequence of served advertisements, although that may in some instances be the case.

The disclosure thus introduces the concept of an episodic advertising campaign where each ad is a chapter in a larger story, narrative arc, or campaign progression. This promotes user engagement by providing a narrative or user-influenced progression that unfolds with each interaction. The system's ability to present these ads in sequence creates a dynamic advertising experience that can adapt to user responses. For example, a user watching a car advertisement might choose a color for an advertised vehicle in one episode, responsive to which subsequent ads in the campaign will show the car in action in the chosen color, creating a sense of continuity and personalization.

In some example embodiments, the episodic advertisements of the ad campaign may be implemented via storylets, in particular examples comprising video content storylets. In this context, a storylet is a narrative unit usable in interactive storytelling, for example in video games and interactive fiction. It is a modular piece of story that can stand alone or be combined with other storylets to create a larger, more complex narrative. Each storylet typically contains a segment of the story, complete with its own plot points, characters, and decision points that can influence the story's direction. Storylets are designed to be flexible and can be triggered by specific conditions or states within the campaign state or, in game-related implementations, a game state, such as a user's previous choices, achievements, character relationships, or other game variables. This allows for a non-linear storytelling experience where the narrative unfolds uniquely for each player based on their interactions and decisions within the game. The concept of storylets enables writers and game designers to craft stories that are responsive to player actions, creating a dynamic and personalized narrative experience. Instead of following a fixed storyline, players encounter different storylets woven together based on the evolving context of the game or ad campaign progression, leading to multiple possible outcomes and story paths. For example, in a game-related ad campaign utilizing storylets, a user might encounter a storylet where they must decide whether to help a character in need. The outcome of this storylet could then unlock new storylets, each with its own set of choices and consequences, further expanding the narrative landscape of the game.

Note that although the disclosed techniques for the provision of episodic advertisements in some embodiments provide for game-related advertisements and are described below with reference to detailed examples in the context of a game-related ad campaign, application of the disclosed techniques is not limited to the gaming industry and can be implemented with respect to a wide array of non-gaming products or services. This versatility allows for creating immersive and interactive ad campaigns that can engage users in various sectors by providing them with a decision-making process that persists across the campaign and/or transcends an individual advertisement. The advertisements'episodic nature can thus ensure that each user's journey through the ad campaign is individually choice-dependent and tailored to their previous interactions, thereby fostering a deeper connection with the advertised product or service.

For instance, consider the above-mentioned example of a vehicle advertising campaign for a new car model. The first episodic advertisement could present the user with a scenario where they choose the environment for a test drive—either a bustling cityscape or a rugged mountain trail. Based on the user's selection, a second episode could showcase the car's features suited for the chosen environment, such as advanced navigation systems for the city or enhanced suspension for off-road conditions. In a third episode, the user might be prompted to select an interior design package, with the subsequent ad revealing a customized interior based on their choice. A final episode could offer the user a recap of their configured car, highlighting their selections such as the color, features, and interior, and inviting them to schedule a real test drive or place a pre-order, with the campaign state data ensuring that the car presented is consistent with their choices throughout the campaign.

In some implementations, the system maintains campaign state data specific to the user, updating this data based on user interactions. The selection of subsequent episodic advertisements is based on this updated campaign state data. The system evaluates eligible advertisements and selects the next episode accordingly. The system's maintenance of campaign state data ensures that each user's path through the episodic ads is unique and tailored. This data acts as a digital memory of the user's choices, informing the content of future ads. The campaign state data is thus employed to create a personalized narrative experience, akin to saving a game's progress. For instance, in a campaign for a streaming service, the user's genre preferences could dictate the type of content highlighted in future ads. In example embodiments where the ad campaign is for a computer-implemented game, the campaign state data may comprise user-specific data indicating a game state and/or a world state for a virtual world in which the game is set.

In some examples, the system provides for the autonomous selection of successive candidate advertisements in the campaign, for example, based on parametrized criteria. By evaluating the campaign state data, the system, in some such examples, filters through the episodic ads in the relevant campaign to find a match for the user's current narrative position. This step is akin to choosing a storyline branch in a video game based on the player's previous actions. In a campaign for a fitness app, for example, the system might present a workout challenge based on the user's prior engagement with beginner-level exercises.

The advertising campaign may provide for predefined sequencing and/or sequencing contraints of episodic advertisements in the ad campaign according to a plurality of different potential sequences, each such sequence providing a structured narrative framework or campaign progression while allowing for user-driven variations. Such mechanisms ensure the presentation of a coherent story arc adaptable to individual user choices. The sequencing of episodic advertisements can in some examples be implemented through various storylet selection criteria, which may include user interaction history, user demographic data, and specific campaign goals. For instance, an episodic ad campaign for a new game might use a selection criterion based on the user's preferred game genres or previous interactions with similar game ads. This tailored approach not only enhances user engagement but also optimizes the relevance of each ad episode presented to the user.

The predefined sequencing (e.g., implemented as qualifying criteria for candidate ads, such as previous presentation of particular preceding ads and/or satisfaction one or more preconditions pertaining to campaign state data resulting from prior user actions) acts as a roadmap for the campaign, guiding the user through a series of connected experiences. The particular sequence of episodic ads and/or the particular content of at least some of the ads are in some examples variable between different instances, variability being responsive to user interaction, so that the narrative arc of the ad campaign is driven by user choice/action, ensuring that the narrative or progression remains engaging and relevant. Thus, the provision of choices to the user in one episodic advertisement may, in some examples, set the stage for a campaign that evolves based on those decisions. This feature underscores the interactive nature of the campaign, where user engagement directly influences the storyline. The choice-dependent progression makes each user's experience with the campaign unique. For example, an ad campaign for a financial services company using the disclosed techniques may guide a user through a series of investment options, with each ad building on the user's previous financial decisions.

In some examples, the method may include generating the episodic advertisements of the ad campaign using a template system which may, in some instances, define advertisement templates with variables and presentation components. In some instances, these variables may be bound at runtime based on user-specific data, including the campaign state data. Such provision of a template system for generating episodic advertisements allows for efficient and scalable ad creation and may enable the dynamic assembly of ads based on a set of predefined templates customizable with user-specific data. Such use of templates, in some instances employing storylets as described below, facilitates the creation of a diverse range of narrative possibilities within the campaign.

The binding of variables within advertisement templates to user-specific data allows for the customization of ads, ensuring that the content of each episodic advertisement is relevant to the user's interests and/or past interactions. The binding process is akin to filling in the blanks of a story with details specific to the user. For example, in a campaign for a music streaming service, the user's choice of a favorite music genre could lead to ads featuring artists and playlists from that genre. In some examples, the selection of data bindings for the variables within the advertisement template is based at least in part on the current campaign state data for the user, thus achieving auto-selected episodic advertisements that are not only personalized but also reflect the user's past interactions with the campaign. The data binding selection is a critical step in maintaining the relevance of successive episodic ads in a campaign and in developing a coherent and consistent narrative through the campaign.

By way of brief illustration, consider an example storylet template for a game-related ad campaign which includes variables such as ‘character_decision’, ‘environment_setting’, and ‘plot_twist’. Each variable can be bound at runtime based on previous user interactions, ensuring that each ad episode is not only unique but also contextually relevant to the user's ongoing game narrative. This approach allows for a highly personalized advertising experience, where the user's choices directly influence the storyline of the ads they are presented with.

In some examples, the template system comprises a plurality of storylets, the use of which introduces a modular approach to narrative construction in advertisements. As mentioned, each storylet defines a self-contained narrative segment that can be combined with others to form a larger story. This modular design allows for flexibility and personalization in the campaign.

In some examples, the system further includes a recap module that autonomously composes a recap of previous episodic advertisements based on the current state of the campaign. This recap is presented to the user at commencement of a non-initial episodic ad to reinforce the narrative continuity and the impact of their choices in previous episodic ads in the campaign. Such recaps serve as a narrative bridge between episodic advertisements, reminding users of their previous interactions and choices within the campaign. This feature enhances the storytelling aspect of the campaign by providing users with a summary of their journey so far. The recap module can be particularly effective in long-running campaigns where continuity is of relatively greater importance. For example, a user returning to a multi-part ad series for a video game might be presented with a recap of the story elements they've previously encountered. In some such examples, the system selects content from previously presented episodic ads t o create a recap tailored to the user's experience. This automated process allows for efficient and consistent recaps across the user base.

Aspects of the disclosure provide for ad campaigns related to computer-implemented games, the episodic advertisements including interactive content that allows users to engage with the game world. This feature provides a taste of the gameplay and can serve as an effective teaser for the full game. The interactive content is selected and configured to be representative of the actual game, providing an authentic experience. In such cases, interactive content related to the game may be generated using in-game assets, allowing users to interact with a game world specific to the game. In such computer-implemented examples, campaign state data which is automatically maintained may in some embodiments explicitly include a current game state (which may include world state, character state, scores, assets acquired, etc.) or may in other embodiments permit the derivation or reconstruction of the current game state for the user. Further in this description, updating of game states and the like is to be understood as encompassing both: (a) explicitly storing such states in a datastore; and (b) updating campaign state data (e.g., campaign history) that permits reconstruction or linear derivation of the current state data.

The use of in-game assets in visual representations of the game world in episodic advertisements ensures that the ads are visually and thematically consistent with the game being advertised. This feature allows for a more immersive and engaging ad experience, as users are exposed to the same characters, environments, and aesthetics found in the game. Integration of in-game assets helps to create a cohesive brand experience across the campaign. For example, a user might see the same character models and environments in the ads as they would in an action-adventure game, reinforcing the game's branding and appeal. A variety of in-game assets that may be used in episodic advertisements, separately or in combination, includes but are not limited to visuals, audio, text, video content, characters, and storylines that contribute to the storytelling and interactive elements of the ads. The inclusion of a wide range of assets allows for a multifaceted representation of the game world. In a campaign for an RPG game, the ads could feature character dialogues, battle scenes, and exploratory sequences that give users a glimpse into the game's narrative and mechanics.

As mentioned, example methods comprise dynamically maintaining and updating a current game state for the user based on their interactions with respective episodic ads in the campaign. The updated game state from the advertising campaign can in some examples be carried over to the actual game if the user decides to initiate playing the full game, e.g., by installing the full game on their client device or otherwise starting gameplay via a game server system or other platform which manages or provides playing of the game, also referred to herein as direct gameplay. The game state update and storage in such cases provide a seamless transition from ad interaction to direct gameplay. For instance, a user's strategic choices in a playable ad for a strategy game could determine the starting resources available when they begin playing the full game.

In some such examples, the campaign progression experienced by the user may comprise a narrative arc crafted to mirror a story progression found within the game, providing users with a coherent and enticing storyline. The episodic nature of the ads allows for the narrative to develop over time, much like episodes in a television series. For example, a campaign for a mystery game might unfold the clues and plot twists over several ads, enticing users to solve the mystery by engaging with each episode.

Thus, playable episodic advertisements for a computer-implemented game introduce an interactive element to the campaign, allowing users to actively participate in a limited portion of gameplay. This interactivity can increase user engagement and interest in the game by providing a hands-on experience and thus serving as a bridge between passive viewing and active participation. Instances in which the episodic ads comprise interactive scenes and story content within the playable advertisements allow users to make choices and engage with the narrative, promoting a subjective experience of increased agency and involvement compared to traditional techniques. For instance, in a campaign for an adventure game, users might choose which path to take in a branching storyline, with each choice leading to different challenges and rewards within the ad campaign.

Instead or in addition, the dynamically updated game state in some examples comprises a world state that is indicative of one or more variable aspects of the virtual in-game world and that is persisted through their interactions with subsequent episodic advertisements in the campaign. Such persistence of optional world state changes allows the user's choices to have lasting effects on the game world presented in the ads. For example, in a campaign for a city-building game, the user's choice to focus on green energy in the one episodic ads could result in a cleaner and more sustainable city environment within the game world in subsequent episodic ads within the campaign.

In some embodiments, transfer of the game state to direct gameplay allows the user's interactions to result in a personalized starting point in the game based on the user's ad interactions. For instance, if a user during the ad campaign selects to build a farm with certain selected features or configurations, it may result in the user starting direct gameplay with a farm already having those features or configurations. In other words, an updated game state (which may in some instances include an updated world state) may be synchronized with a later installation or game instance when direct gameplay is implemented. Such a synchronized game state may include various components that reflect the user's journey through the episodic advertising campaign. These components, such as acquired in-game assets, character development states, and narrative progression points, ensure that the user's experience in the game aligns with their interactions in the ads.

In some embodiments, synchronization of the game state from the ad campaign with an actual game instance providing for full gameplay is optional. In such cases, the system may at installation or subscription provide users with the option to import the stored game state into their game instance upon initiating the game.

In summary, the disclosure in some implementations provides a comprehensive solution for creating a personalized and engaging advertising experience that leverages the narrative and interactive potential of storylets within the technical constraints of digital ad delivery systems. It addresses the challenges of previous approaches by ensuring continuity, relevance, and technical feasibility across multiple ad exposures and user interactions.

### Description of Example Embodiments

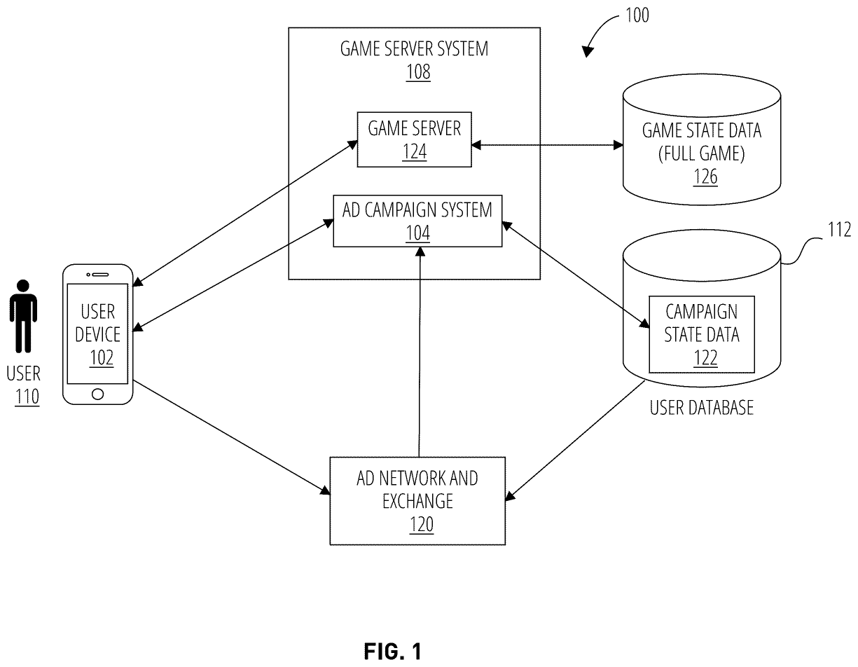

Referring now to FIG. 1, therein is shown an example network environment and system 100 for the generation, delivery, and management of an episodic advertising campaign according to one example. System 100 includes an ad campaign system 104, which in this example forms part of or is otherwise functionally integrated into a game server system 108 for the provision and management of computer-implemented online games, an ad campaign with respect to which the disclosed techniques are discussed below in this example being for the advertisement of one of a number of games hosted by the game server system 108. The example of FIG. 1 is in particular configured for delivering a personalized and engaging advertisement experience that evolves based on user interaction with episodic advertisements related to a computer-implemented game.

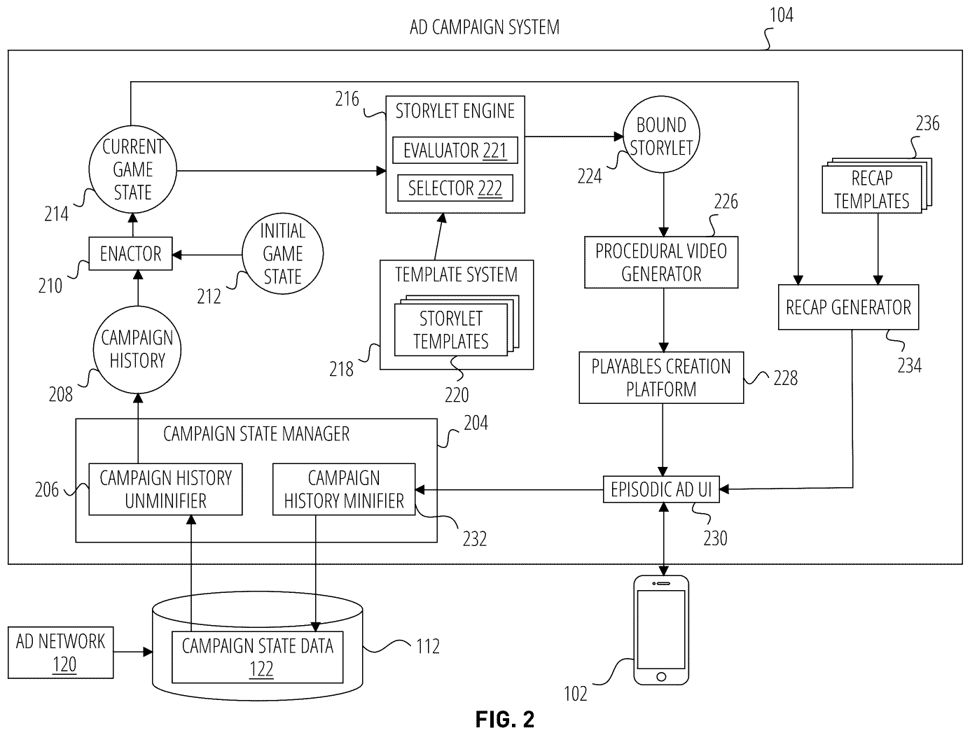

The episodic ad system 104 is configured to generate, store, provide, and manage an episodic advertising campaign and its associated episodic advertisements, which are segments of a campaign progression defined by multiple episodic advertisements presented in sequence. In this example, each episodic advertisement is a storylet-based playable narrative segment of a particular computer-implemented game provided by a game server system 108, with a sequence of the playable episodic ads together providing a narrative arc set within a virtual world within the game. Further details of the architecture and functions of the example episodic ad system 104 are described in greater detail below with reference to FIGS. 2, 4, and 5.

Note, again, that although the example systems and methods described with reference, particularly to the provision and management of an advertising campaign, similar or analogous systems can, in other embodiments, be implemented for providing advertising campaigns for non-game products and/or services. In such an example, the episodic ad system 104 or an analogous system can be a standalone service, can be integrated into a non-game server system, and/or can be integrated at least partially by the ad network 120.

In FIG. 1, user device 102 represents a client-side computing device associated with a particular user 110, the user device 102 being capable of receiving and displaying interactive advertisements, such as a smartphone, tablet, laptop, or desktop computer. The user device 102 includes a display interface for presenting episodic advertisements to the user device 102 and capturing user interactions in the form of user inputs, as well as a communication interface for transmitting data over a network (e.g., the Internet) via which the respective elements of the networked ecosystem of FIG. 1 is in communication. In a particular example, the user device 102 is a mobile phone with a touchscreen for displaying video-based interactive ads and receiving user inputs in the form of touchscreen selections and/or text inputs. The display interface may utilize various technologies, such as LCD, OLED, or e-ink, to provide a high-quality visual presentation of the episodic advertisements, which may include rich media content like video, animation, and interactive elements that engage the user in the narrative-driven ad experience.

In this example, an ad network 120 operates as an intermediary between the episodic ad system 104 and the user device 102. The ad network 120 in this example manages a bidding process for ad placement opportunities and facilitates the delivery of selected episodic advertisements to the user device 102.

The game server system 108 provides full gameplay services for the computer-implemented game associated with the advertising campaign. It maintains game state data 126 (e.g., including world state data together with other game state attributes) for users who engage in direct gameplay, e.g., via installation of a game application on the user device 102 and/or via subscribed browser-based gameplay managed by the game server system 108. The game server system 108 may be configured to support multiplayer interactions, real-time gameplay updates, and persistent world management, ensuring that the game experience is consistent and engaging for all players. The game server system 108 may also include mechanisms for tracking user progress, managing virtual economies, and enforcing game rules.

The system further includes a user data store or user database 112, in this example being a specialized repository designed to accessibly store campaign state data 122, which, in the context of the described example of a game-related advertising campaign, indicates or allows for the derivation of game state data, which may include world state data for a virtual in-game world or gameboard of user 110 with respect to limited gameplay enacted via interaction with the episodic ad campaign. In this context, game state data refers to a collection of variables that define the current conditions and progress of a user's interaction within the game-related advertising campaign. In this example, the campaign state data 122 indicates campaign history data, identifying by ad or ad template ID a subset of episodic ads from the campaign which has already been served to user 110, the order of their presentation, and details of user interactions with the respective ads (e.g., the particular choices made by user 110 at each respective decision point in the respective previously presented ads in the campaign.)

Current game state data that may be derived from campaign history data (or which may, in some examples, be stored persistently in an accessible datastore such as user database 112) may include, for example, achievements unlocked during the ad interactions, such as any virtual items or rewards that the user has obtained. World state data, which in the present example implementation is managed as a component part of the game state data, pertains to the current state of the virtual in-game environment or game world presented within the game-related ads. It encompasses elements such as optional installed game assets or features, configurations and/or conditions of in-game assets and/or gameboard layouts, and other environmental conditions that can be influenced by the user's decisions in episodic advertisements of the campaign. By storing and updating this data in response to user interactions, the user database 112 ensures that each user's experience is not only personalized and consistent across the advertising campaign but also, in this example, that user progress as to the advertised game can be seamlessly integrated with the game world when they transition to direct gameplay.

In this example, campaign data update and management functions are performed by the episodic ad system 104, but note that such functions may, in other embodiments, be provided at least in part by the episodic ad network 120. The ad network 120, in this example, employs algorithms to optimize ad placement based on various factors, including user demographics, behavior, and the context of the user's current activity. This optimization process aims to maximize the relevance and impact of the ads presented to the user, thereby increasing the likelihood of user engagement and interaction.

Networked connection (e.g., via the Internet) between components of the system 100 enables communication between the user device 102, episodic ad system 104, ad network 120, game server system 108, etc. It allows for the transmission of data, including user interactions, campaign state data, and episodic advertisement content. The network may be implemented using various communication protocols and technologies, such as TCP/IP, Wi-Fi, LTE, or 5G, to provide a robust and high-speed connection that supports the data-intensive nature of the interactive advertisement system.

In operation, as will be described in greater detail below with reference to FIGS. 2 and 4-6, the episodic ad system 104 receives from the ad network 120 a request for an advertisement to be served to user 110. Based on the user's previous interactions (e.g., as reflected in the campaign state data 122 of the user database 112), the episodic ad system 104 selects and/or generates appropriate episodic advertisement and delivers it to the user device 102 for presentation. The selection process may involve decision-making algorithms that consider the user's interaction history, preferences, and the narrative structure of the campaign to ensure that the chosen advertisement aligns with the user's unique journey through the campaign.

User interactions with the episodic advertisement are captured by the user device 102 and transmitted back to the episodic ad system 104. In other examples, ad presentation can be performed via the ad network 120 or another avenue other than the episodic ad system 104, with such delivery mechanisms receiving user interactions with the episodic ads and updating the campaign state data 122 in user database 112 accordingly. In this example, in which ad presentation is provided via an ad interface hosted by the episodic ad system 104 (see, e.g., episodic ad UI 230 in FIG. 2), such user input data is received by episodic ad system 104, which updates the campaign state data accordingly. Continual updating of the campaign state data 122 prepares the episodic ad system 104 for the selection of the next episodic advertisement in the sequence, responsive to reception of a subsequent ad request. The updated campaign state data is thus used to inform the content and choices presented in subsequent advertisements, creating a personalized and evolving narrative experience for the user.

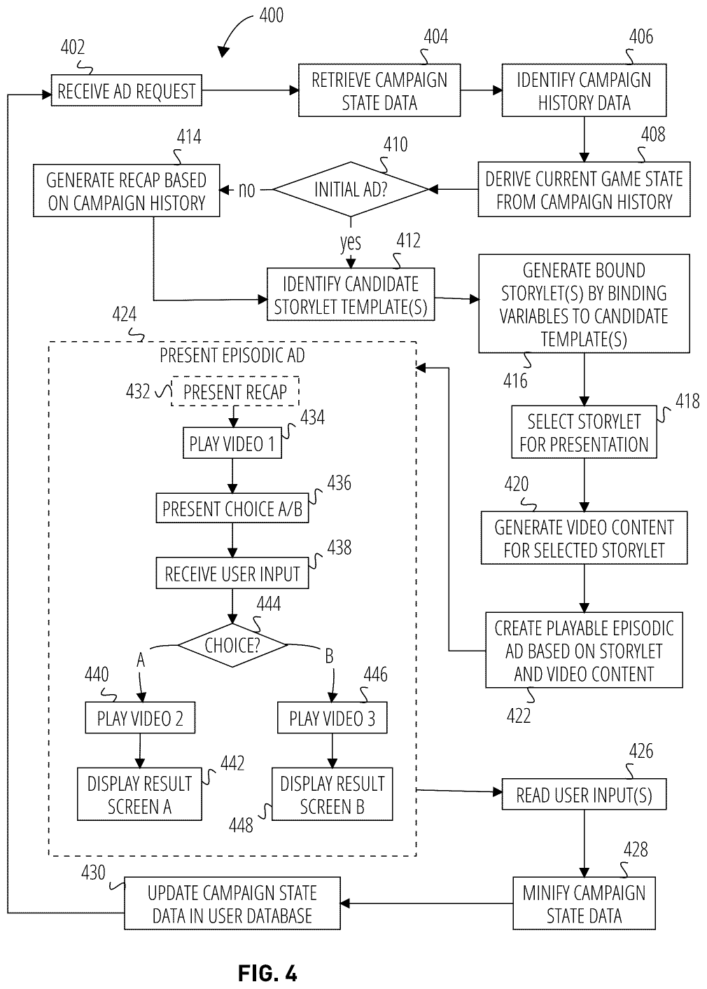

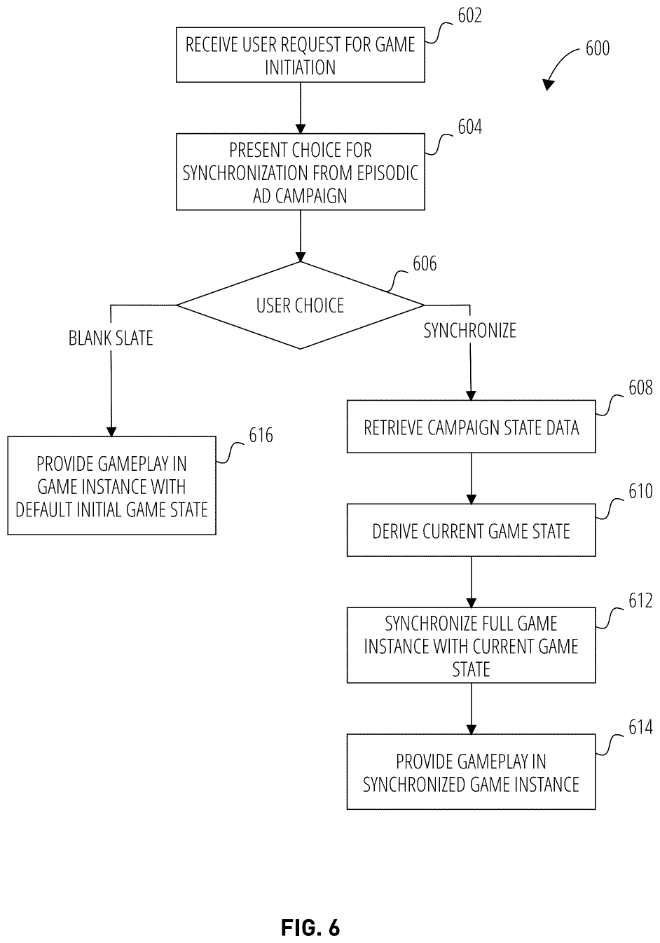

If the user decides to engage in direct gameplay, the game server 124 for that game can access the user database 112 to retrieve the updated campaign state data 122, from which a current game state (including world state) for user 110 resulting from ad campaign interactions can be read or reconstructed. Upon initiating full gameplay, user 110 is, in this example, then presented with an option to synchronize progress or game state from the episodic ad campaign. If the user opts for synchronization, current game state data from the ad campaign is used as initial game stat data 126 for the full game. The game server system 108 may also provide options for the user to continue the narrative from the advertising campaign within the game, promoting a continuous gameplay experience from the ad campaign to full gameplay. Alternatively, the user 110 may opt to start full gameplay with a blank slate. These features are described in greater detail with reference to FIGS. 4 and 6 below.

FIG. 2 is a schematic diagram illustrating the architecture and data flow of an ad campaign system 104 according to some examples. The functionality of the respective components of FIG. 2 introduced below are described in greater depth and can best be understood in conjunction with the descriptions of FIG. 4-6 below.

FIG. 2 is presented in conjunction with the network environment and system 100 depicted in FIG. 1, illustrating the architecture and data flow of the ad campaign system 104 as it pertains to the delivery of episodic advertisements. This schematic diagram elucidates the intricate workings of the ad campaign system 104, which is instrumental in managing and delivering a personalized episodic advertising campaign to users, thereby enhancing their engagement with the advertised game, such as the example of Farmville administered by the game server system 124.

The campaign system 104 includes campaign state manager 204, which oversees the retrieval, maintenance, and updating of campaign state data 122. This data is pivotal in tracking the progression of a user through the episodic advertising campaign, ensuring that each advertisement is not only relevant but also reflective of the user's previous interactions and choices within the campaign. In this example, campaign state data 122 is stored in condensed or minified form. Accordingly, the campaign state manager 204 comprises campaign history unminifier 206 and campaign history minifier 232, which operate in concert to efficiently manage the user's interaction history with the episodic advertisements. The unminifier 206 expands the minified data to reconstruct a comprehensive view of the user's journey through the campaign, while the minifier 232 condenses this interaction history, optimizing data storage and retrieval. This dual mechanism facilitates a streamlined and dynamic selection process for subsequent episodic advertisements, tailored to the user's evolving narrative journey.

An enactor 210 is provided and configured to take in unminified campaign history 208 and an initial game state 212 and based on these inputs to reconstruct or derive a current game state 214 for the player based on past interactions with the ad campaign.

The episodic ad system 104 further comprises a predefined ad campaign comprising a set of storylet templates 220 stored for the ad campaign in a template system 218. The multiple storylet templates 220 within a particular set provide the building blocks for the episodic advertisements to be delivered as part of the respective ad campaign. These storylet templates 220 are predefined with variables that are dynamically bound to data specific to the user's current state within the ad campaign based on prior choices/actions and/or a current world state or campaign state, thereby generating a customized storylet for the relevant episodic ad. This allows for the customization of the narrative content to reflect the user's previous interactions and current game state.

In other words, each storylet template serves as a foundational blueprint from which individual storylets are generated and presented to the user. Each template defines a potential narrative segment customizable at run time by binding instance-specific data to respective variables of the storylet template. As will be discussed at greater length in the Example Storylet Template Structure section below, each storylet template in some examples defines preconditions for its selection. The preconditions are configured to cause selection of the storylet templates during the course of the campaign in a narratively coherent and consistent sequence, as discussed at greater length below.

Variable binding in some examples comprises both static and/or dynamic binding. Static binding is based on static facts of the ad campaign (e.g., particular characters that are present in the narrative segment regardless of user history or campaign/world state), being facts that do not vary from one instance of deployment of the template to another. In contrast, dynamic variable binding is based on something that has dynamically changed in the campaign/world based, e.g., on prior player actions. For example, a precondition in a storylet template for a hangout scene may define that the relevant scene only happens if there exists a character with which the player has an affinity value greater than 5, affinity being a variable of the world state that can change with play based on player choices in previous episodic ads of the campaign.

This mechanism enables tailoring the advertisement narrative to the user's unique journey and interactions within the game, providing a deeply personalized ad experience, thus allowing for the automated building of a respective narrative arc during the progression of the ad campaign by auto-selection of respective bound storylets based on satisfaction of specific preconditions. These templates are designed to be flexible and reusable, allowing for the dynamic assembly of narrative content that can adapt to the evolving interactions of the user with the campaign. The use of storylet templates enables the creation of a rich, multi-threaded narrative experience that maintains coherence and relevance throughout the user's journey.

Storylet engine 216 utilizes the template system 218 to generate the episodic advertisements. it comprises two key components: evaluator 221 and selector 222. The evaluator 221 assesses the user's current game state to identify which storylet templates are applicable, while the selector 222 chooses the most appropriate template for the next episodic advertisement based on the user's narrative progression. The storylet engine 216 additionally binds applicable variables identified from the current game state 214 to the selected template, outputting the resultant bound storylet 224 to a playable creation pipeline frontend, provided in this example by procedural video generator 226. Utilizing the template system 218 with pre-defined storylet templates 220, the storylet engine 216 thus crafts personalized narrative segments based on the user's current game state 214. This process ensures that each episodic advertisement is a coherent continuation of the user's unique narrative within the advertised game. For instance, in an episodic advertising campaign for a game in the Farmville genre, the storylet engine 216 might select a template that presents the user with a choice to expand their farm with new crops or livestock based on their enacted preferences in previous interactions.

Procedural video generator 226 is tasked with creating video content for the selected storylet. This component transforms the narrative and interactive elements of the storylet template into engaging video segments that visually convey the story to the user. Playables creation platform 228 takes the output from the procedural video generator 226 and constructs a playable episodic advertisement. This platform integrates interactive elements, such as user choices, with the video content to create a cohesive and engaging advertisement experience.

Episodic ad UI 230 provides a user interface through which the episodic advertisements are presented to the user. It is designed to facilitate user interaction with the advertisement, capturing user choices and feeding this data back into the system to influence subsequent narrative segments.

Recap generator 234 serves to enhance narrative continuity by providing users with recaps of their previous interactions within the ad campaign. This component selects relevant content from past episodic advertisements to remind users of their journey and set the context for upcoming narrative segments. Recap templates 236 are utilized by the recap generator 234 to structure the recap segments. These template s define the format and content of the recaps, ensuring that they are coherent and effectively communicate the user's narrative progression.

### Example Storylet Template Implementation

As discussed, the episodic advertisement system, in some examples, utilizes a storylet template mechanism that allows for dynamic narrative progression based on user interactions. Each storylet template is defined with specific variables and preconditions that must be met for the storylet to be selected in any particular instance. This section provides a detailed example of how such storylet templates function in a particular example implementation, including the process of variable binding and the selection criteria based on preconditions.

An example configuration for storylet templates 220 will now be described at the hand of a specific example storylet template, populated with a number of example data fields and example values, after which follows a brief description of the functioning of respective fields or variables in the specific example. It will be appreciated the example storylet template configuration and implementation format provide but one example of a number of different configurations that can be implemented in different examples.

The example storylet template that follows is in this instance a structured JSON object that defines various aspects of a narrative segment within an episodic advertising campaign. Below is first a summary of the storylet template structure followed by a brief discussion description of each section of the code and its function. Sections abbreviated in the introductory Template Structure are separately expanded and discussed thereafter.

### Example Storylet Template Structure

{
   “id”: 7,
   “tags”: [“multi-choice”],
   “repeatable”: false,
   “priority”: 10,
   “required_storylets”: [4]
   “variables”: {
      “c1”: “character”,
      “c2”: “character”,
      “c3”: “character”,
      “v2”: “value”,
      “l1”: “location”,
      “j1”: “job”
   },
   “preconditions”: [ . . . }
   “actions”: [ . . . ]
   “choices”: [ . . . ]
}“Id” is a short identifier unique to each storylet template. It is used in storylet history to keep track of which storylets have been served to the player, ensuring that the correct narrative content is accessed and manipulated when needed.

The “tag” attribute is a descriptor for indicating the content or the structure of the storylet. For example, the storylet template indicates in this example that the storylet is of a predefined “multi-choice” type/category, being a storylet that involves one or more choices for the user between multiple options. This communicates to the system the type of user interaction expected. Instead, or in addition, tag values are in some examples used in storylet selection or sequencing and can be used to filter or select storylets based on the campaign's design requirements. For example, in an ad campaign that includes storylet templates of types “Multi-choice” and “Relationships,” (the latter of which is for storylets focused on developing relationships between characters), a trigger for selecting the next template from the relationships type can be coded into the system, for example in the storylet templates as a dynamic precondition or via template filtering logic forming part of the selector 222, which can use the tag values to filter for storylet templates limited to relationships.

The “repeatable” attribute indicates whether or not the storylet can be shown multiple times during any single instance of the ad campaign. In this example, the “false” value defines the storylet template as a one-time event, the template being excluded from selection after first being served to the user during the ad campaign, even if all its preconditions are satisfied. Some examples provide for at least some repeatable storylet templates within an ad campaign. It will be understood that in such instances, amongst others, narrative progression of the sequence of presented episodic ads can be non-linear, for example including repeated presentation of some storylets.

“Priority” indicates an assigned priority level of the storylet, which is in some instances used by selector 222 to determine precedence among multiple candidate templates that meet the preconditions. A higher number indicates a higher priority.

“Required Storylets” is an array that lists storylet IDs for those storylets that must all have been presented already in the campaign before the present storylet template qualifies for selection. Assignment of storylet IDs and Required Storylet values within the set of storylet templates at design time ensures that the narrative unfolds in a coherent and logical sequence, respecting the designed story arc. Some examples are additionally used to determine recap priority.

The “variables” section of the example storylet template defines the variables that are used within the storylet. Each variable (c1, c2, c3, v2, l1, j1) represents different elements such as characters, values, locations, and jobs that are relevant to the storylet's narrative. These variables are placeholders that are bound to actual data (e.g., world state data) based on the user's campaign history and/or interactions. Thus, during runtime, the storylet engine 216 binds these variables during runtime, populating the storylet template based on world state information to produce a bound storylet. “Preconditions” define a set of criteria that must be satisfied in order to make this storylet template eligible for selection. The preconditions typically involve checks against the campaign state, e.g., including attributes of a world state and/or the user's previous choices in the campaign. For example, a precondition might require that the user has achieved a certain level of affinity with a specified other character or has completed specific tasks. In some examples, preconditions may also be used to bind specific information. For example, specifying that C1 must be named Marie means that evaluator 221 will bind the character Marie to the variable C1 at runtime.

In the present example storylet template whose structure is set out above, the expanded Preconditions Section reads as follows:

### Example Storylet Template Preconditions

“preconditions”: [
   {
      “condition_type”: “char_property_value”,
      “terms”: [“c1”, “job”, “Archaeologist”]},
   {
      “condition_type”: “char_property_value”,
      “terms”: [“c2”, “job”, “Museum Curator”]},
   {
      “condition_type”: “char_tag”,
      “terms”: [“c3”, “player”]},
   {
      “condition_type”: “char_val_char”,
      “terms”: [“c2”, “v2”, “player”]}
      ],

As mentioned, the preconditions section of a storylet template is determinative in controlling when a particular storylet is eligible for selection to be activated within an episodic advertising campaign. Each precondition is a rule that must be satisfied for the storylet to be presented to the user. This mechanism ensures that the narrative content is relevant and appropriately timed based on the user's interactions and the state of the campaign. At storylet selection, the evaluator 221 runs through the entire set of storylet templates 220 for the campaign to identify all qualifying storylet templates 220 based on their respective preconditions.

Preconditions in some examples include a specified value for an attribute/variable of the campaign state (in the case of a game-related campaign being a game state or world state). For example, the first precondition in the above example checks if a specific property (attribute) of a specific character meets a predefined target value. This ensures that characters in the storylet fit certain roles or characteristics necessary for the narrative. In particular, the first precondition requires that the character identified as c1 must have the job attribute of “Archaeologist”. The storylet will only be eligible for selection if this character is indeed an Archaeologist, aligning the story content with the character's story background, aesthetics, and dialog. Similarly, the second precondition requires that the character c2 has the job attribute of “Museum Curator.”

The preconditions may, in some examples, include tags or labels assigned to characters or other campaign/game elements. The third precondition in the above storylet template, for example, checks for a tag associated with a character (which can be used to identify special roles or states within the campaign), in particular checking that character c3 is tagged as the “player”, typically representing the user. This enforces personalizing the storylet to the user's perspective and ensuring that the narrative is centered around the user's actions.

In some examples, one or more preconditions may pertain to character relationships. Such a precondition may, in some examples, specify a target relationship type so that the precondition is satisfied only if the type of relationship between the specified characters is the target relationship type. For example, the precondition {“condition_type”: “char_tag_char”, “terms”: [“c1”, “acquaintances”, “c2”]} checks if the character represented by c1 has an “acquaintances” relationship with the character represented by c2. If this relationship exists as specified, then the precondition is met, and the storylet can proceed or be activated based on this condition. This allows the narrative to branch or include content that is contextually relevant based on the relationships between characters, enhancing the depth and personalization of the story.

Instead, or in addition, a precondition may specify a threshold value for a variable attribute of a bilateral character relationship, the attribute having a dynamic value that can change over the course of the narrative. The fourth precondition of the example storylet template presented above provides such an instance, specifying that the value v2 associated with c2 (in this instance being an affinity or strength of relations) in relation to the “player” must meet certain criteria. In particular, the value for v2, being the threshold value for the player affinity, is, in this instance, bound at runtime and may be dynamically defined. In other instances, a static value may be defined in the template, for example requiring affinity to be higher than 5 on a scale of 0 to 9. This allows the storylet to adapt based on evolving relationships, enhancing the dynamic storytelling aspect.

In this example, the selection of this storylet template is conditional on all of the preconditions being satisfied, which in this instance include both static roles and dynamic interactions. For example, the precondition that the storylet will only trigger if ‘c1’ is an Archaeologist is a static role assigned to the character, while the precondition that ‘c2’ (the Museum Curator) has an above-threshold affinity with the player is a dynamic attribute that could have been influenced by earlier interactions in the game.

In other examples, the selection criteria for a storylet template may define two or more alternative preconditions, so that satisfaction of any one of the alternatives triggers selection eligibility. For example, the selection criteria may require two or more grumpy characters, or two or more characters with value 5 affinity with the player, in which case the template will be triggered for selection with anything that matches those conditions, A hangout scene implemented by a specific storylet might be unlocked with Marie or alternatively with Doug if affinity with both characters is greater than 5 in value.

It will be appreciated that the particular character, complexity, and interplay of preconditions as dynamic variables affecting template selection can in other implementations be selected and configured in many different ways at the discretion of an author of the set of templates, for example including complex multivariate mathematical or logical expressions at the prerogative of the storylet author.

The preconditions in a storylet template directly influence the flow and relevance of the episodic advertising campaign. By ensuring that storylets are triggered only when these conditions are met, the campaign can offer a highly personalized and contextually appropriate experience to the user. This not only increases engagement by making the content more relevant and timely but also enhances the narrative depth, as users see their actions and choices having tangible effects on the story progression.

Overall, the use of detailed preconditions helps maintain a coherent and immersive narrative that adaptively responds to the user's journey through the campaign. This strategic deployment of content based on user-specific data ensures that each interaction feels meaningful and impactful, thereby increasing the effectiveness of the advertising campaign and fostering a deeper connection between the user and the brand.

The Actions Section of the storylet template defines what happens when the storylet is triggered and presented to the user. In this example, the Actions Section includes actions with a choice field, being run responsive to and conditional on a particular player choice. Although such choice actions are separately identified in the example template under a “choice”: [ . . . ], this segment of the example template is to be understood as effectively being a subsection of the Actions Section.

In this example, such actions include narrative exposition (like the “opener”) and any sequences of dialogue or events (like the “dialog sequence” in the example code below) that occur within the storylet. Actions thus serve to present the relevant narrative segment to the user, advancing the narrative arc of the campaign and providing the user with context and engagement. In other words, the Action Section specifies what happens in an ad presented for each storylet, allowing for modular effects. In the present examples, these include information about UI changes and text information, as well as changes to the game state.

A choice field of actions in this example describes if the action should be run based on a player's choice; if the field is set to 0, the action should, in this example implementation, always be run. Otherwise, the respective action is to be run only if that choice has been selected. In the present example storylet template whose structure is set out above, the example Action Section (including a Choices subsection reads as follows:

### Example Actons & Choices Section

{
“actions”: [
{“action_type”: “opener”, “text”: “c1 was plowing the fields and hit something hard.”},
{“action_type”: “dialog_sequence”, “dialog_sequence”: [
{“speaker”: “c1”, “text”: “Whoa! Look at this artifact! It looks ancient!”, “location”: “BOTTOM_LEFT”},
{“speaker”: “c2”, “text”: “You should give this artifact to the museum for inspection, it could be cursed. Also, you'll be rewarded handsomely . . . ”, “location”: “BOTTOM_RIGHT”}
]}
],
   “choices”: [
{“choice”: 1, “choice_requester”: “c1”, “choice_text”: “Keep the artifact.”, “hidden”: false, “noop”: false,
“actions”: [
{“action_type”: “dialog_sequence”, “dialog_sequence”: [
{“speaker”: “c2”, “text”: “Hrmph, you'll regret this.”, “location”:
“BOTTOM_RIGHT”}
]},
{“action_type”: “results_info”, “recap_text”: “You kept the artifact at the farm.”, “results”: [
{“subject”: “c2”, “subject_image”: “defaultPortraitIcon”, “effect_image”: “angry_face”, “results_text”: “c2 is angry”}
]},
{“action_type”: “enact_effect”, “effects”: [
{“type”: “char_val_char_change”, “terms”: [“c2”, “−1”, “c3”], “truth”: true},
{“type”: “property_tag”, “terms”: [“artifact”, “at_farm”], “truth”: true}
]}
]},
{“choice”: 2, “choice_requester”: “c2”, “choice_text”: “Give to museum.”, “hidden”: false, “noop”: true,
“actions”: [
{“action_type”: “dialog_sequence”, “dialog_sequence”: [
{“speaker”: “c2”, “text”: “Thank you for your cooperation.”, “location”: “BOTTOM_LEFT”}
]},
{“action_type”: “results_info”, “recap_text”: “You gave the artifact to the museum.”, “results”: [
{“subject”: “c2”, “subject_image”: “defaultPortraitIcon”, “effect_image”: “happy_face”, “results_text”: “c2 is happy”},
{“subject_image”: “farm_wealth”, “effect_image”: “up_arrow”, “results_text”: “Farm wealth has increased”}
]},
{“action_type”: “enact_effect”, “effects”: [
{“type”: “char_val_char_change”, “terms”: [“c2”, “1”, “c3”], “truth”: true},
{“type”: “property_value_change”, “terms”: [“farm_wealth”, “10”], “truth”: true}
]}
]}
]

The various components and functional interaction of the above example Actions Section, including Action with Choice Fields will be clear to a person skilled in the art from interrogation of the provided example code, but are briefly discussed below for clarity. It will be seen that the Actions include an Opener, which defines text to display at the beginning of the storylet. This action sets the initial scene or context for the storylet. For example, “c1 was plowing the fields and hit something hard.” This opener establishes the setting and introduces a pivotal moment in the narrative.

A Dialog Sequence follows which involves a series of exchanges between characters, designed to deepen the narrative and engage the user. Each dialog sequence specifies the character speaking, the text, and the location on the screen where the dialog appears. For instance, character c1 discovers an artifact, and character c2 suggests it should be inspected. These dialogues not only advance the story but also introduce the conflict or decision point that involves the user.

The Choices Section outlines the potential decisions a user can make in response to the scenario presented by the Opener and the dialogue sequence and defines for each choice a series of actions performed pursuant to its selection. Note that the example template in this instance provides for two alternative choices responsive to the initial dialogue sequence, with only the actions of the selected choice being executed. This section thus provides for interactivity, allowing the user to influence the story's progression and causing changes to the campaign state specific to the user.

Each choice is uniquely identified (e.g., “choice”: 1), facilitating tracking and processing user selections. A Choice Requester attribute indicates which character in the story is associated with this choice, adding a layer of personalization and context to the decision (e.g., “choice_requester”: “c1”), and Choice Text defines the actual text presented to the user, representing the decision to be made (e.g., “Keep the artifact.”).

Each choice leads to a series of actions that define the consequences of the user's decision. These actions can include additional dialog sequences, results information, and the enacting of effects that alter the narrative or game state based on the choice made. For example, a dialog sequence provides predefined further dialogue that reflects the immediate reaction to the user's choice, enhancing the narrative depth and interactivity of the ad experience (e.g., “Hrmph, you'll regret this.”). A respective Results Info action provides a summary or recap of the choice's outcome, which can include visual and textual feedback (e.g., showing a character's emotion like anger or happiness).

A respective Enact Effect action for each choice serves to implement the actual effects of the respective choice in the narrative, differently changing the campaign history and campaign state (e.g., character or world state attributes in the present example). This could thus comprise changing character relationships, modifying environment attribute values, updating resource levels (e.g., increasing farm wealth), or the like.

The integration of the Actions and Choices sections ensures that each storylet is not only a piece of narrative but also a dynamic interaction point with the user. This structure allows for dynamic story progression, so that the narrative evolves based on real-time user decisions, making each user's experience unique. Involving users in this manner interactively in the narrative development has the benefit not only of increasing user engagement but of increasing memorability of the experience, which is a particular aim of advertisement campaigns. The use of variable bindings and user-driven choices ensures that the content is highly personalized, increasing relevance and effectiveness.

### Variable Binding

Turning now to customization of the storylet templates to specific instantiations, it will be recalled that storylet templates are populated with specific data by variable binding at runtime, thus producing bound storylets. In instances that include binding of dynamic variables (which are non-static but instead respond to evolving campaign/game state based on the user's actions), the resultant bound storylet reflects the consequences of the user's prior choices, allowing the advertisement narrative to adapt dynamically. In other words, after the user has made specific choices that affect the campaign/game state, the storylet template is bound with actual data.

An example bound storylet is described below, generated from the above example storylet template by dynamic variable binding, which comprises dynamically assigning character roles and attributes based on previous choices made by the user based on hypothetical campaign history. It will be seen that one or more campaign state and/or campaign history facts dynamically affect the final form of a bound storylet produced from the template so that different instances of variable binding can produce differently populated and/or functionally different bound storylets. Note that dynamic variable binding is in some examples pertinent not only to the population of template variables with actual data (thus customizing aspects of presented ads such as the identity of characters, world aesthetics, and so forth) but additionally affecting storylet selection and narrative sequencing, for example, via one or more storylet preconditions that are dynamically variable with variations in campaign history. In such instances, the particular storylets and/or the sequence of ads served to the user during the ad campaign are determined in part by user choices/actions. The set of storylet templates for an ad campaign may, for example, include divergent, alternative narrative branches so that some storylet templates are in certain campaign instances never eligible for selection during the entire extent of the campaign.

For example, if a user in an ad campaign for a faction-building game in a previous episodic ad chose to ally with a faction ‘The Northern Guild’, increasing their reputation with this group, a subsequent storylet requiring a ‘trusted faction’ would dynamically bind to ‘The Northern Guild’. This storylet might involve a critical negotiation scene that only occurs due to the user's high reputation with the faction, directly influenced by the user's previous decisions.

For dynamic binding of the present example storylet, campaign history may include, say, that the user, during interaction with an earlier episodic ad in the campaign, chose to help the Museum Curator, increasing the affinity value between the player character and the Museum Curator. The variable c2 may thus previously be bound to “Museum Curator” because of the user's previous interactions that increased their affinity with this character. The variable v2 is set to “High” to reflect this strong relationship.

### Example Bound Storylet

{
“id”: 7,
“tags”: [“multi-choice”],
“repeatable”: false,
“priority”: 10,
“required_storylets”: [4],
“variables”: {“c1”: “Elara”,
“c2”: “Museum Curator”,
“c3”: “Player”,
“v2”: “High”,
“l1”: “Archaeological Site”,
“j1”: “Archaeologist”
},
“preconditions_met”: true,
“actions”: [
{
“action_type”: “opener”,
“text”: “Elara was plowing the fields at the Archaeological Site and hit something hard.”},
{
“action_type”: “dialog_sequence”,
“dialog_sequence”: [
{
“speaker”: “Elara”,
“text”: “Whoa! Look at this artifact! It looks ancient!”,
“location”: “BOTTOM_LEFT”},
{
“speaker”: “Museum Curator”,
“text”: “You should give this artifact to the museum for inspection, it could be cursed. Also, you'll be rewarded handsomely . . .”,
“location”: “BOTTOM_RIGHT”}
]}
],
“choices”: [
{
“choice”: 1,
“choice_requester”: “Elara”,
“choice_text”: “Keep the artifact.”,
“hidden”: false,
“noop”: false,
“actions”: [
{
“action_type”:
“dialog_sequence”,
“dialog_sequence”: [
{
“speaker”:
“Museum Curator”,
“text”: “Hrmph, you'll regret this.”,
“location”: “BOTTOM_RIGHT”}
]},
{
“action_type”: “results_info”,
“recap_text”: “You kept the artifact at the farm.”,
“results”: [
{
“subject”: “Museum Curator”,
“subject_image”: “defaultPortraitIcon”,
“effect_image”: “angry_face”,
“results_text”: “Museum Curator is angry”}
]},
{
“action_type”: “enact_effect”,
“effects”: [
{
“type”: “char_val_char_change”,
“terms”: [“Museum Curator”, “−1”, “Player”],
“truth”: true},
{
“type”: “property_tag”,
“terms”: [“artifact”, “at_farm”],
“truth”: true}
]}
]},
{
“choice”: 2,
“choice_requester”: “Museum Curator”,
“choice_text”: “Give to museum.”,
“hidden”: false,
“noop”: true,
“actions”: [
{
“action_type”: “dialog_sequence”,
“dialog_sequence”: [
{
“speaker”: “Museum Curator”,
“text”: “Thank you for your cooperation.”,
“location”: “BOTTOM_LEFT”}
]},
{
“action_type”: “results_info”,
“recap_text”: “You gave the artifact to the museum.”,
“results”: [
{
“subject”: “Museum Curator”,
“subject_image”: “defaultPortraitIcon”,
“effect_image”: “happy_face”,
“results_text”: “Museum Curator is happy”},
{
“subject_image”: “farm_wealth”,
“effect_image”: “up_arrow”, “results_text”: “Farm wealth has increased”}
]},
{
“action_type”: “enact_effect”,
“effects”: [
{
“type”: “char_val_char_change”,
“terms”: [“Museum Curator”, “1”, “Player”],
“truth”: true},
{
“type”: “property_value_change”,
“terms”: [“farm_wealth”, “10”],
“truth”: true}
]}
]}
]}

As can be seen, the storylet template is, in this instance, dynamically bound with specific data based on previous user choices. The variable c2 is thus indeed bound to “Museum Curator” as a result of the user's previous interactions that increased their affinity with this character. The variable v2 is set to “High” to reflect this strong relationship. The preconditions check if c1 is an “Archaeologist” and if c2 is a “Museum Curator,” both of which are true in this scenario, allowing the storylet to be selected.

The example bound storylet demonstrates how variable bindings are used to tailor the narrative to the user's previous decisions, ensuring that the story progresses in a way that is consistent with their actions and relationships within the game world. The user choices, variable bindings, and storylet selection cooperate synergistically to create a personalized and engaging episodic advertisement experience emergent from the modular storylets and without pre-definition and implementation of an overarching narrative structure or episode sequence at a higher level.

The sequence of storylets in an episodic ad campaign is determined by a combination of user choices and predefined narrative paths. Each choice within a storylet can lead to different subsequent storylets, creating a branching narrative structure. The system uses the outcomes of user choices to update the campaign state data, which in turn influences the selection of the next storylet. This method ensures that the narrative arc remains coherent and personalized, with each user experiencing a unique storyline that evolves based on their interactions.

This dynamic and responsive approach to episodic advertising not only enhances user engagement but also provides a rich narrative experience that can significantly boost the effectiveness of the advertising campaign.

Selection of storylets based on template preconditions and dynamic variable binding as described allows for and automatically implements non-linear sequencing of storylets in the episodic advertisement system, the particular sequence of presentation instead being influenced by and variable as a factor of a combination of user choices, template preconditions, and variable bindings. This non-linear sequencing allows for a multitude of narrative pathways, each uniquely crafted based on the user's interactions.

To illustrate, consider the following simplified example of non-linear sequencing that includes narrative branching with divergent narrative arcs in different instances based on user interactions:
Initial Storylet: The user encounters a dilemma where they must choose to save a village or pursue an enemy. The choice made here influences the variable ‘moral alignment’.
Subsequent Storylet Selection
   If the user chooses to save the village ('moral alignment: good'), the next storylet features a celebration event in the village, enhancing the user's reputation.
   If the user pursues the enemy ('moral alignment: ruthless'), the next storylet involves discovering enemy secrets, leading to different strategic advantages.
Further Branching:
   From the celebration event, the user might receive a request for help from another village, continuing the ‘heroic’ narrative arc.
   From discovering secrets, the user might be faced with a moral decision about using the information, which could lead to further reputation changes and subsequent storylets.

This example illustrates how template precondition configuration, variable bindings and user choices can cooperate to allow multiple potential narrative arcs, each tailored to the user's actions and preferences. Such complexity in ad sequencing promotes rich, individualized user experiences, further engagement, and memorability.

Note that aspects of the disclosure pertaining to the use of modular storylets with selection preconditions in narrative sequencing are not limited only to episodic ad campaigns but can, in other examples, be implemented in other applications or environments receptive to the provision of narrative segments via storylets or the like. The disclosed modular storylets with selection preconditions in narrative sequencing offer significant technical and practical benefits, particularly in the context of creating flexible, user-driven narratives without the constraints of a central, linear storyline. This bottom-up approach to storytelling, where each storylet stands as an independent narrative unit but can be seamlessly integrated into a broader narrative framework, provides a robust method for maintaining narrative consistency and relevance.

Firstly, modular storylets inherently allow for a high degree of narrative flexibility. Unlike traditional linear narratives that require the user to follow a predetermined path, modular storylets enable a more organic story development that reacts to user choices. Each storylet can branch out in various directions based on the user's interactions, leading to multiple potential narrative outcomes. This flexibility not only caters to a more personalized user experience but also significantly enhances replayability and user engagement.

A further benefit is that the precondition system ensures that each storylet fits logically within the overall narrative context, regardless of the user's previous choices. By setting specific criteria that must be met for a storylet to be activated, the system can effectively prevent narrative or environmental inconsistencies. For example, a storylet involving a celebration can be preconditioned to only appear if the user has achieved a certain milestone or victory in previous interactions. This method ensures that the narrative remains coherent and contextually appropriate, enhancing the user's immersion and satisfaction.

Another benefit of the preconditioned storylet template system, as disclosed, pertains to scalability and ease of content management. From a content creation perspective, modular storylets are significantly easier to manage and scale compared to a central narrative structure. Each storylet can be designed, tested, and modified independently without affecting the overall narrative framework. This modularity allows content creators to introduce new storylets or modify existing ones based on user feedback or changing marketing goals without the need for extensive revisions to the entire narrative. Additionally, the precondition system helps manage how these storylets are sequenced, ensuring that new additions harmonize with the existing narrative elements.

Additionally, the bottom-up approach facilitated by modular storylets configured for automated non-linear sequencing via dynamic modular preconditions allows for dynamic content delivery that is highly responsive to user behavior. Since there is no rigid narrative to follow, the story can dynamically evolve based on real-time data regarding user choices and preferences. This responsiveness not only makes the narrative more engaging but also allows advertisers to tailor their messaging and content to better meet user expectations and interests, potentially leading to higher conversion rates and user retention.

Yet further, the disclosed storylet mechanism facilitates comparatively easy and foolproof prevention of inconsistent or incoherent narrative segments, in practice. This is because each storylet can be prevented from causing narrative or environmental inconsistencies by crafting its preconditions to ensure that the storylet is activated only when preconditions consistent with its narrative segment are present. These preconditions thus act as filters that ensure only contextually suitable storylets are presented to the user. For instance, a storylet that involves a character the user has never met or an event that contradicts earlier choices will not be triggered unless the preconditions —such as prior introduction of the character or alignment with previous events —are satisfied. This selective triggering not only maintains narrative integrity but also reduces the cognitive dissonance users might experience with less coherent storytelling. In conclusion, the technical and practical benefits of using modular storylets with selection preconditions are manifold, offering a sophisticated framework for delivering personalized, engaging, and consistent narrative experiences in interactive media and advertising. This approach not only enhances user engagement through personalized storytelling but also provides content creators with a flexible and scalable tool to adapt narratives to user feedback and evolving marketing objectives.

### Example Implementations of Methods For Ad Campaigns

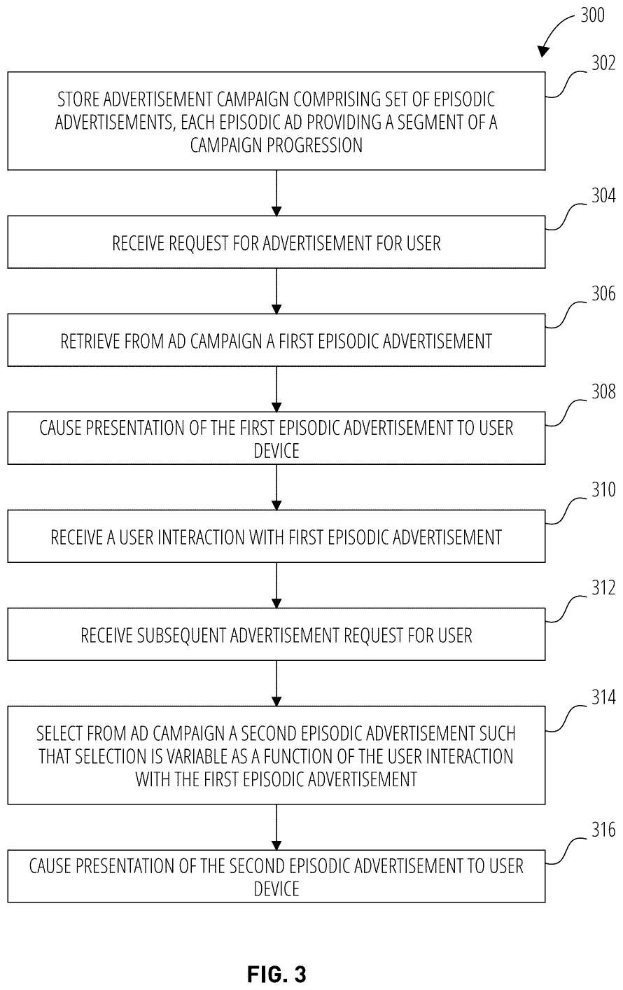

FIG. 3 provides a high-level overview of a method 300 for delivering an episodic advertising campaign, illustrating broadly one example of a process of engaging users with a series of interconnected advertisements that collectively form a cohesive narrative or campaign progression. The method serves to enhance user engagement by leveraging narrative episodic content, thereby offering a dynamic and interactive advertising experience that is tailored to the individual user's journey through the campaign.

In operation 302, method 300 stores an advertising campaign comprising a set of episodic advertisements, each episodic advertisement comprising a segment of a campaign progression defined by a plurality of the episodic advertisements presented in sequence. This structured approach to campaign design ensures that each advertisement contributes to the unfolding narrative, engaging the user with a story that evolves with their participation. Sequencing of ads presented in the campaign is, in some examples, determined by preconditions for presentation predefined for each episodic advertisement. In some embodiments, the set of episodic advertisements comprises a set of storylet templates configured for variable binding at runtime, as described in some examples below.

Upon receiving a request for an advertisement to be presented to a user (operation 304), the system retrieves a first episodic advertisement from the advertising campaign (operation 306). Note, again, that said first episodic advertisement is not necessarily an initial episodic advertisement in the ad campaign, although that may in some instances indeed be the case. The system then causes the presentation of this first episodic advertisement to the user's device (operation 308).

In operation 310, user interaction with the first episodic advertisement is received. This interaction, which may involve making a choice or performing an action within the advertisement, is pivotal in determining the direction of the narrative progression. The user's interaction signifies their active participation in the unfolding story, influencing the content and direction of subsequent episodic advertisements.

In response to receiving a subsequent request for an advertisement to present to the same user (operation 312), the system selects a second episodic advertisement from the advertising campaign (operation 314). The selection of this second episodic advertisement is variable and directly influenced by the user's interaction with the first episodic advertisement. This ensures that the narrative progression experienced by the user is personalized and reflective of their choices, enhancing the relevance and engagement of the advertisement content.

The system then causes the presentation of the second episodic advertisement to the user's device (operation 316). This subsequent episodic advertisement builds upon the narrative foundation established by the first advertisement and the user's interactions with it, further advancing the story and deepening the user's engagement with the campaign.

In summary, FIG. 3 outlines a method for delivering an episodic advertising campaign that dynamically adapts to user interactions, providing a personalized and engaging narrative experience. Through the sequential presentation of episodic advertisements that respond to the user's choices, the method fosters a deeper level of user engagement and offers advertisers a novel approach to capturing user interest and participation.

FIG. 4 is a flow diagram illustrating, at a more detailed and granular level, method 400 for providing an episodic ad campaign for game-related content, specifically detailing the execution of an ad campaign for Farmville, as executed by the ad campaign system 104 of FIG. 2, according to some examples. The method 400 is further described at the hand of an example ad campaign and example episodic ads for a computer-implemented game in which a player character controlled by a player of the game manages a farm located in a virtual game world or gameboard specific to the user, also referred to herein as Farmville. Episodic ads for this ad campaign are to be served to the user 110 at respective trigger points during play by the player 110 of a different game provided and managed by the game server system 108.

At operation 402, the system receives an ad request for the target user 110 from the ad network 120. This request initiates a sequence of events within the ad campaign system 104 to deliver a personalized episodic advertisement for a particular game (in this example, said Farmville-style game) hosted by the game server system 108 to the user device 102 of the user 110. The request from the ad network 120 includes a user ID for user 110.

At operation 404, the campaign state manager 204 retrieves campaign state data 122 for the target user indicated by the received user ID. The campaign state data 122 in this example comprises a condensed record of the user's progression through the ad campaign, being stored in a minified format for efficiency. At operation 406, the campaign state manager 204 unminifies the retrieved campaign state data 122 to identify campaign history 208, which in this example indicates the specific episodic ads previously served to the user 110 in the campaign, together with choices made by the user 110 for the respective historic ads.

At operation 408, the enactor 210 derives a current game state 214 from the campaign history 208. This involves reconstructing the user's position within the narrative of the Farmville game world based on their past interactions. The current game state 214 indicates current variables of the user's progression within the game based on previous interactions with the ad campaign. In this example, the current game state 214 can indicate aspects of a world state (conditions, states, configuration, etc. of features within the game world), assets acquired by the user (including virtual in-game assets located within the game world, consumable assets such as currency), current values of variable attributes for the player character (e.g., health, energy, attributes of character relationships, score values, and the like). An example of such variables can include in this example, for instance: ‘cropType=wheat’, ‘farmSize=large’, or ‘animal=cow’, enabling determination of the narrative context for the user's ad experience.

If system 104 determines, at operation 410, based on the campaign history 208 and/or the current game state 214, that this is not the initial ad of the ad campaign for user 110, in other words, that one or more episodic ads from the relevant campaign have previously been presented to user 110, the recap generator 234 proceeds to generate, at operation 412, a recap based on the campaign history 208 and a set of predefined recap templates 236. This recap provides the user with a brief overview of their previous choices and the resulting game state and/or world state. In other words, the recap generator 234 takes the player history and converts this data into a recap to be sent to user 110. This may comprise parsing the campaign history 208 and picking out important events that happened in the past to serve to the frontend. In the Farmville example, the recap may replay one or more previous choices and illustrate the current state of their farm, e.g., “Previously, you chose to plant wheat and expand your farm” and showing a pictorial or video view of the current farm state.

Thereafter, or directly after operation 410, if it is determined that the present request is for the initial ad in the campaign, it is passed to storylet engine 216 for initiating the generation and presentation of an appropriate playable video-based episodic ad for target user 110.

At operation 414, evaluator 221 forming part of storylet engine 216 identifies, from the set of storylet templates 220 stored in template system 218 for the ad campaign at issue, candidate storylet template(s) 200 which qualify for the present ad request. As mentioned previously, each storylet template 200 represents a potential narrative segment set within the game world of the advertised game. These storylet templates 220 are pre-designed with variables that allow for customization based on the user's game state, and that allow in the present example for automatic sequencing of the episodic ads so that the respective sequence of ads that are presented to the user presents a coherent and logical campaign progression. In the context of a game-related ad such as the present example, campaign progression comprises a narrative arc that is variable depending on the user's choices at various points in the ad campaign. In addition to the dynamic selection of storylets based on user interactions, as described above, the evaluator 221 in this example incorporates fallback mechanisms to ensure a seamless narrative experience. These mechanisms are designed to maintain engagement and narrative flow, even in scenarios where a user's past choices do not align with available specific content. For example, when more specific storylets cannot be served due to a lack of matching user history or other criteria, evaluator 221 defaults to presenting predefined generic storylets. These storylets are crafted to be broadly relevant and engaging, ensuring that every user interaction contributes positively to the overall narrative experience, regardless of their journey's uniqueness. The fallback storylets are seamlessly integrated into the user's narrative journey, with adaptive scripting that acknowledges the potential variance in user experiences. This approach allows for a cohesive narrative that can dynamically adjust to include these more general storylets without disrupting the storyline's continuity or the user's sense of agency within the ad campaign.

At operation 416, the evaluator 221 performs variable binding of the candidate storylets and passes on the resultant bound storylets to the selector 222. Specific variable values, such as the type of crops grown or the animals raised on the user's farm are thus inserted into the candidate storylet template 220, creating a bound storylet. The variable binding operation 416 thus involves populating the template with the user's specific data, resulting in a personalized narrative segment. For instance, if the user's current game state indicates they have been successful with wheat (‘cropType=wheat’), the narrative might be populated to read, “With a thriving crop of wheat, do you invest in more land to expand your farm?”

In summary, a procedure performed by the evaluator 221 in this example comprises:
For each storylet template, check if the template's preconditions are satisfied by the current world state.
If so, bind the appropriate values to the template variables
Return a dictionary of bound storylets.

At operation 418, selector 222 forming part of the storylet engine 216 selects for surfacing one of the set of bound storylets produced by the evaluator 221 as being valid for the current world state, ensuring in this example that the narrative presented to the user is a direct continuation of their unique Farmville story. The storylet engine in this example additionally transforms the selected storylet into a format that can be ingested for procedural player generation, and then passes off this object (bound storylet 224 in the data flow of FIG. 2) to a playable creation pipeline commencing with procedural video generator 226. In this example, operation 418 comprises:
From the list of possible storylets, filter out storylets identified as undesired based on predefined criteria (e.g., unrepeatable events that have happened in the user's personal experience of the campaign, or repeatable storylets whose previous occurrence is too recent, having been served in the last n timesteps).
Score remaining storylets based on predefined attributes (ex. higher priority, has characters the user has seen before, etc.)
Return highest scoring storylet (or some random selection from the top highest scoring storylets).
Format chosen storylet with any data tweaks necessary for ingestion.

To further enhance the dynamic and personalized nature of the episodic advertisements, selector 222 in some examples incorporates mechanisms of wildcard usage and randomization in the selection of storylets. These features introduce an element of unpredictability and variety, ensuring that each user's narrative journey remains unique and engaging. In some examples, certain storylets are thus designed with wildcard attributes, allowing them to be flexibly inserted into various narrative contexts. These wildcard storylets can adapt to a wide range of user histories and choices, serving as versatile narrative pieces that enrich the storytelling experience without requiring a direct match to specific past user interactions.
a. The selection of storylets for presentation to the user in some examples includes a randomization process, weighted by predefined criteria such as user engagement levels, narrative relevance, and previous storylet exposure. To this end, the scoring of respective storylets can in such an example thus comprises calculating respective score based on a number of weighted factors. Such a process ensures that, while the narrative remains coherent and personalized, users are also likely to encounter unexpected developments and story arcs, enhancing the sense of discovery and engagement with the ad campaign. Integrating wildcard storylets and employing randomization in storylet selection allows for automated ad selection that not only caters to the diverse narrative paths chosen by users but also promotes the replayability of the ads. Users are thus in some examples encouraged to engage with the campaign multiple times, discovering new narrative facets and outcomes with each interaction, which in turn amplifies the overall effectiveness of the advertising campaign.

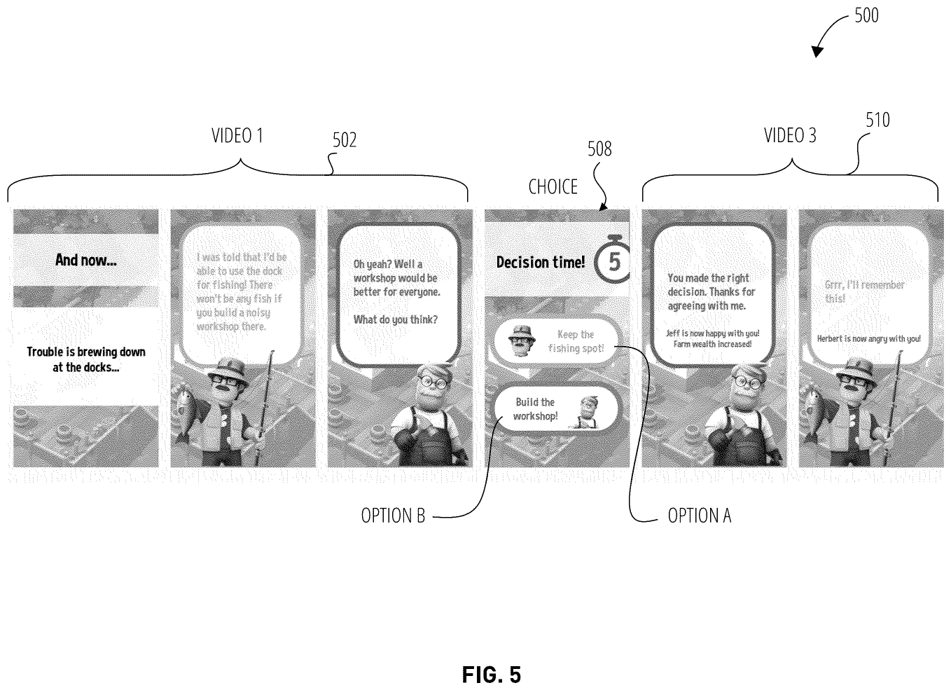

At operation 420, the procedural video generator 226 generates video content for the selected storylet, which may include scenes of the user's farm or interactions with Farmville characters, as depicted in the example screenshots of FIG. 5. Procedural video generator 226 is configured to take in bound storylet 224 and use it to render videos that use the storylet's bindings, e.g., particular characters, world state features, and text.

In this example, each playable episodic ad comprises one decision point at which the user is presented with alternative selectable options. Accordingly, the procedural video generator 226 in this example generates three videos based on bound storylet 224. The first video (e.g., intro video 502 in FIG. 5) contains the information that the user will see before their choice, the second video (e.g., video 2 510 in FIG. 5) shows what they will see if they select the first choice (e.g., option A in FIG. 5), and the third video contains the information that they will see if they select the second choice (e.g., option B in FIG. 5). Videos 2 and 3 each additionally includes a result screen displayed at the end of the respective video segment, illustrating a current state of the game world and/or results of the respective choice. It will be appreciated that, in other examples, each storylet may define more than one branching point, in which case different respective video segments may be generated for all possible branches of the resultant playable's progression.

At operation 426, the playables creation platform 228 creates a playable episodic ad (with videos and selectable user interface elements, e.g., soft buttons) based on the bound storylet and video content, in a format suitable for delivery via episodic ad UI 230 and/or via ad network 120. Note that, in some embodiments, delivery of the episodic ads can be performed via ad network 120 or a different ad interface. The playable video-based episodic ad produced by the playables creation platform 228 can thus be seen as an interactive advertisement that allows user 110 to engage with the presented game world interactively, providing limited gameplay comprising selection of one of the presented options.

The playables creation platform 228 in this example takes in the videos generated by the procedural video generator 226, as well as the choices offered in the selected storylet template, and generates a playable that links together this information, resulting in a playable in which the player is shown some information, is given a choice that they can interact with, and then shown the video corresponding with the results of the choice that they have made. FIG. 5 provide and example UI screenshots 500 of one example of such a playable interactive episodic advertisement, as discussed below with reference to presentation of the episodic ad, at operation 424.

At operation 424, the episodic ad is delivered to target user 110 by presentation thereof via episodic ad UI 230. As mentioned previously, ad presentation is in this example performed at a trigger point in another game which user 110 is currently playing via game server system 108. For example, the example episodic ad for Farmville may in this example be served at a trigger point between levels of primary game that the current is currently playing, say Words With Friends.

In instances where a recap was generated, as discussed previously, presentation of the episodic ad is initiated by, at operation 430, replaying the recap. At operation 434, the UI 230 displays the initial video segment of the episodic ad to the user. This segment, referred to as Video 1 502 in FIG. 5, sets the stage for the user's decision-making. For instance, in a Farmville campaign, Video 1 might showcase the user's farm thriving with the current crop of wheat and hint at the possibility of expansion, creating anticipation for the decision to come. In the example of FIG. 5 intro video, 502 two characters are p resented agitating for the user 110 to build or not to build a workshop on their farm.

Following this, at operation 436, a choice 508 is presented to the user, labeled as Option A/B and presenting respective selectable soft buttons in the UI 230. In the example of FIG. 5, this choice involves deciding whether to forego building of the workshop and thus keeping a fishing spot (Option A) or upgrading the existing farm by building the workshop (Option B). This decision point directly influences the narrative progression and the user's engagement with the ad, and also directly influences the resultant state of the Farm in future episodic ads and/or influences the identity of storylets templates and thus ad experiences which will be available for presentation in future episodic ads in the campaign.

Upon presenting the choices, the system awaits and then receives user input, at operation 438. This input signifies the user's decision, which determines the subsequent narrative path of the ad campaign. In this example the user input comprises selection of option B via touchscreen tap on the corresponding button.

At operation 440, the system determines which video segment to replay next based on the user's choice. In this example, selection of option B triggers replay, at operation 442, of video 3 (indicated by screenshots 510 in FIG. 5). This segment in the present example illustrates construction of the workshop together with reactions from the respective affected characters. At operation 444, a corresponding result screen is displayed, and the ad presentation concludes.

If, however, user 110 were to select option A, then the episodic ad UI 230 would, at operation 446, replay video 2 illustrating an alternative outcome from that of video 3. In the present example, video 2 would illustrate irritation by the character who agitated for the workshop and gratitude from the fisherman. At conclusion of video 2, a result screen associated with video 1 would be presented as conclusion of the episodic ad.

At operation 426, the campaign state manager 204 reads or receives the identity of the episodic ad served to user 110 together with the choice of the user 110 in interacting with the episodic ad. This information is, at operation 428, rendered in minified format by the campaign state manager 204 and, at operation 432, written to the user database 112, thereby updating the campaign state data 122. This updated campaign state data 122 will inform the selection of future episodic ads, maintaining a coherent and personalized narrative throughout the ad campaign.

The above-described procedures of FIG. 4 are repeated for each subsequent ad request received from the ad network 120 for user 110 and pertaining to the ad campaign.

FIG. 6, described below in conjunction with the example network environment and system 100 depicted in FIG. 1 and the example ad campaign system 104 of FIG. 4, illustrates a method 600 of managing a computer-implemented game, which comprises transitioning users from engaging with an episodic advertising campaign to initiating direct gameplay of the advertised game, such as Farmville, which is administered by the game server system 124. This method ensures that the narrative and choices made during the advertising campaign are coherently integrated into the gameplay experience, providing a personalized and immersive game world for the user.

The method 600 begins when the game server system 124 receives (at operation 602) a request for initiating direct gameplay of the advertised game, otherwise referred to herein as playing the full game. Such direct gameplay may in some instances comprise subscribed gameplay via thin client, such as browser-based gameplay. In this example, game initiation comprises download and installation of the advertised game as a client application on the user device 102. The user request for game initiation, at operation 602, thus signifies the user's interest in transitioning from the narrative journey experienced through the episodic advertisements to actively engaging with the game itself.

The game server system 124 then identifies the relevant user ID included in the request, and responsive to identifying that the user 110 has interacted with an episodic ad campaign for the advertised ad (e.g., by determining that the user database 112 has a record for the ad campaign and with the relevant user ID, the user 110 is presented (at operation 604) with an option to synchronize their game instance with the campaign state data 122 accumulated from their interactions with the episodic advertising campaign. This step ensures that users have control over whether their ad campaign choices influence the initial game state. In this example, the game thus prompts user 110 to choose whether to start with a default game setup or to import their choices and progress from the ad campaign.

At operation 606, the game server system 124 receives the user choice whether or not to synchronize. If the user selects the ‘Blank Slate’ option, the game proceeds to provide (at operation 608) gameplay based on a default initial game state. This path does not incorporate the user's interactions from the episodic ad campaign.

For users choosing to synchronize, the game server system 124 retrieves (at operation 610) relevant campaign state data 122 from the ad user database 112, which data encapsulates the choices and interactions made during the episodic ad campaign as experienced by the user and thus effectively summarizes their narrative journey. The game server system 124 then proceeds (at operation 614) to reconstruct the current game state for the user's game instance. This reconstruction involves translating the campaign state data 122 into actionable game states or world states within the game, including but not limited to the world state, character development states, narrative progression points, and acquired in-game assets. This procedure is in this example identical to operation 408 described previously with reference to FIG. 4. This step ensures that the user's personalized narrative journey and the choices they made during the advertising campaign are reflected in the gameplay.

Following the reconstruction of the current game state, the game server 124 (at operation 614) synchronizes the derived current game state with the full game instance, in this example comprising writing the current game state from the ad campaign into a repository for game state data 126 maintained for serving and management of the full game via user device client application. This action updates the game's data repository to include the user's personalized narrative and game world elements, ensuring that the game instance initiated on the user device 102 is tailored to the user's unique journey.

Finally, gameplay is initiated (at operation 616) in the game instance of the advertised and newly installed game (in this example, the advertised Farmville game), with the initial world state, characters, assets, and other elements influenced by the user's interactions with the episodic advertising campaign. This initiation marks the beginning of the user's direct gameplay experience, where the narrative threads and choices from the advertising campaign seamlessly transition into the game's narrative and world, offering a cohesive and enriched gameplay experience.

The above-described and exemplified features provide numerous beneficial functionalities over existing techniques. A non-exhaustive selection of these benefits is briefly discussed below.

The techniques significantly increase user engagement by replacing traditional advertising campaigns with interactive, narrative-driven experiences. By allowing users to make choices that influence the storyline of the ads, it fosters a deeper connection between the user and the advertised content, making the ads more memorable and impactful. Additionally, a highly personalized advertising experience is autonomously implemented by tailoring the content of each episodic advertisement based on the user's previous interactions. Such customization ensures that the ads are relevant to the user's interests and preferences, thereby increasing the likelihood of user engagement and positive reception.

For game-related advertisements, the disclosed techniques seamlessly integrate the advertising narrative with actual gameplay. By synchronizing the user's choices in the ads with the game state, it provides a cohesive experience that can enhance the user's anticipation and excitement for the game, encouraging further engagement with the game itself.

Further, the interactive and episodic nature of the advertisements serves to improve overall ad effectiveness. The engaging format is more likely to capture and retain the user's attention, leading to higher click-through rates and better conversion rates compared to traditional ad formats. The disclosed systems'ability to autonomously generate recaps of previous episodic advertisements ensures narrative continuity, helping users recall their past choices and understand their impact on the ad's storyline. This continuity not only enriches the user experience but also reinforces the connection between the user and the advertised product or service.

The disclosure further invention utilizes a dynamic content delivery mechanism that adapts in real-time to user interactions. This flexibility allows advertisers to present content that is always fresh and engaging, keeping users interested and involved throughout the advertising campaign. By employing a template system for generating episodic advertisements, the disclosed techniques offer a cost-effective solution for content creation. The use of templates streamlines the production process, allowing for the efficient generation of high-quality, interactive ad content without the need for extensive custom development.

While exemplified specifically with reference to game-related advertisements, the disclosed techniques are versatile and readily applicable across various industries. Whether for promoting apps, services, or physical products, the interactive and episodic format can be adapted to suit different marketing objectives and target audiences, making it a valuable tool for a wide range of advertisers.

### Example Network Environment

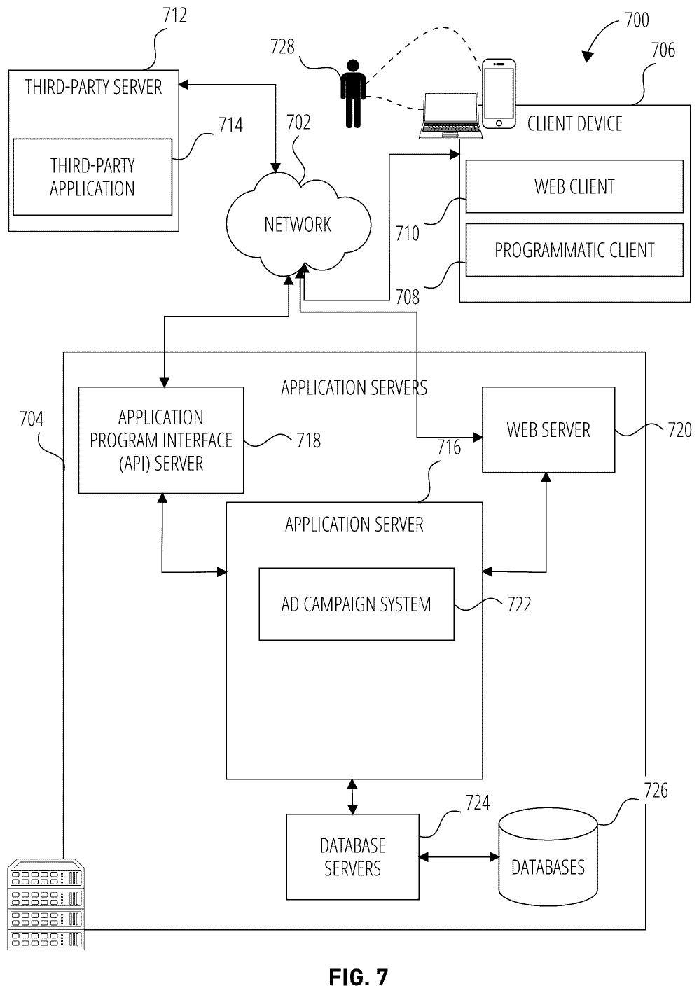

FIG. 7 is a diagrammatic representation of a networked computing environment 700 in which some examples of the present disclosure may be implemented or deployed.

One or more application servers 704 provide server-side functionality via a network 702 to a networked user device, in the form of a client device 706 that is accessed by a user 728. A web client 710 (e.g., a browser) and a programmatic client 708 (e.g., an “app”) are hosted and executed on the web client 710.

An Application Program Interface (API) server 718 and a web server 720 provide respective programmatic and web interfaces to application servers 704.A specific application server 716 hosts an ad campaign system 722, which includes components, modules and/or applications.

The web client 710 communicates with the ad campaign system 722 via the web interface supported by the web server 720. Similarly, the programmatic client 708 communicates with the ad campaign system 722 via the programmatic interface provided by the Application Program Interface (API) server 718.

The application server 716 is communicatively coupled to database servers 724, facilitating access to an information storage repository or databases 726. In some examples, the databases 726 includes storage devices that store information to be published and/or processed by the ad campaign system 722.

Additionally, a third-party application 714 executing on a third-party server 712, has programmatic access to the application server 716 via the programmatic interface provided by the Application Program Interface (API) server 718. For example, the third-party application 714, using information retrieved from the application server 716, may support one or more features or functions on a website hosted by a third party.

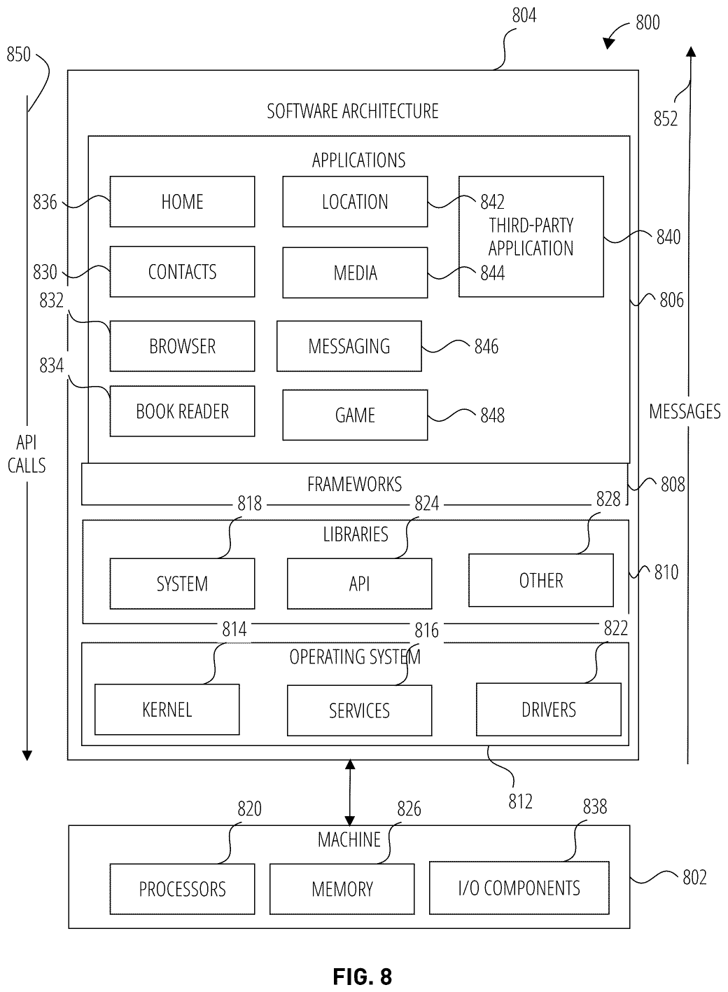

FIG. 8 is a block diagram 800 illustrating a software architecture 804, which can be installed on any one or more of the devices described herein. The software architecture 804 is supported by hardware such as a machine 802 that includes processors 820, memory 826, and I/O components 838. In this example, the software architecture 804 can be conceptualized as a stack of layers, where each layer provides a particular functionality. The software architecture 804 includes layers such as an operating system 812, libraries 810, frameworks 808, and applications 806. Operationally, the applications 806 invoke API calls 850 through the software stack and receive messages 852 in response to the API calls 850.

The operating system 812 manages hardware resources and provides common services. The operating system 812 includes, for example, a kernel 814, services 816, and drivers 822. The kernel 814 acts as an abstraction layer between the hardware and the other software layers. For example, the kernel 814 provides memory management, Processor management (e.g., scheduling), component management, networking, and security settings, among other functionalities. The services 816 can provide other common services for the other software layers. The drivers 822 are responsible for controlling or interfacing with the underlying hardware. For instance, the drivers 822 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, and power management drivers.

The libraries 810 provide a low-level common infrastructure used by the applications 806. The libraries 810 can include system libraries 818 (e.g., C standard library) that provide functions such as memory allocation functions, string manipulation functions, mathematic functions, and the like. In addition, the libraries 810 can include API libraries 824 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., Web Kit to provide web browsing functionality), and the like. The libraries 810 can also include a wide variety of other libraries 828 to provide many other APIs to the applications 806.

The frameworks 808 provide a high-level common infrastructure used by the applications 806. For example, the frameworks 808 provide various graphical user interface (GUI) functions, high-level resource management, and high-level location services. The frameworks 808 can provide a broad spectrum of other APIs that can be used by the applications 806, some of which may be specific to a particular operating system or platform.

In some examples, the applications 806 may include a home application 836, a contacts application 830, a browser application 832, a book reader application 834, a location application 842, a media application 844, a messaging application 846, a game application 848, and a broad assortment of other applications such as a third-party application 840. The applications 806 are programs that execute functions defined in the programs. Various programming languages can be employed to create one or more of the applications 806, structured in a variety of manners, such as object-oriented programming languages (e.g., Objective-C, Java, or C++) or procedural programming languages (e.g., C or assembly language). In a specific example, the third-party application 840 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 840 can invoke the API calls 850 provided by the operating system 812 to facilitate functionality described herein.

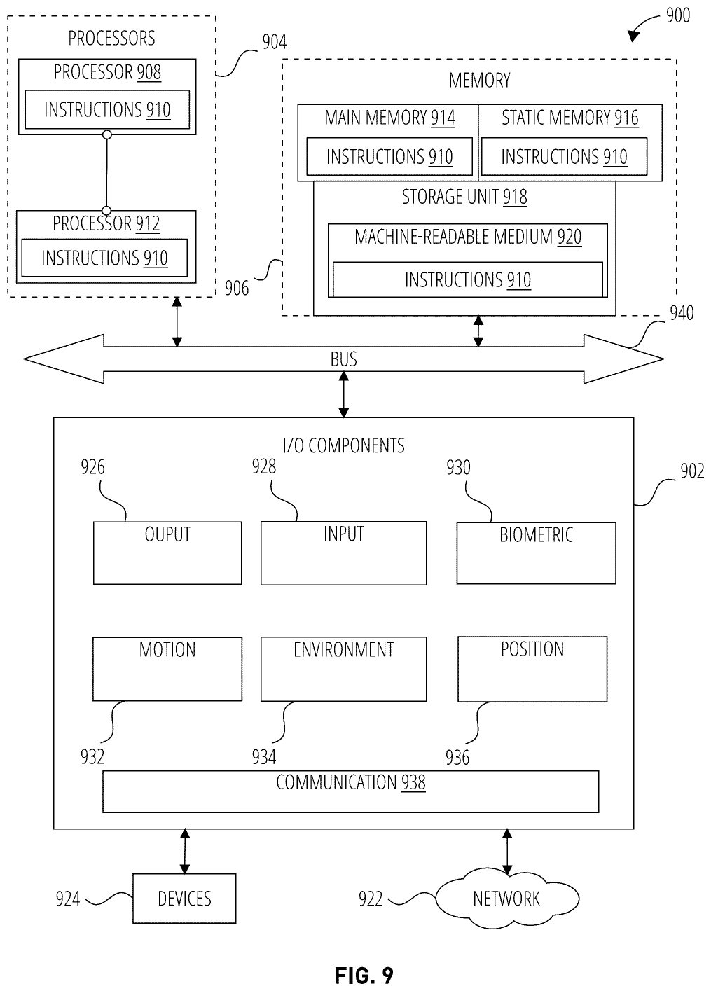

FIG. 9 is a diagrammatic representation of the machine 900 within which instructions 910 (e.g., software, a program, an application, an applet, an app, or other executable code) for causing the machine 900 to perform any one or more of the methodologies discussed herein may be executed. For example, the instructions 910 may cause the machine 900 to execute any one or more of the methods described herein. The instructions 910 transform the general, non-programmed machine 900 into a particular machine 900 programmed to carry out the described and illustrated functions in the manner described. The machine 900 may operate as a standalone device or be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but not be limited to, a server computer, a client computer, a personal computer (PC), a tablet computer, a laptop computer, a netbook, a set-top box (STB), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 910, sequentially or otherwise, that specify actions to be taken by the machine 900. Further, while a single machine 900 is illustrated, the term “machine” may include a collection of machines that individually or jointly execute the instructions 910 to perform any one or more of the methodologies discussed herein.

The machine 900 may include processors 904, memory 906, and I/O components 902, which may be configured to communicate via a bus 940. In some examples, the processors 904 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application-Specific Integrated Circuit (ASIC), a Radio-Frequency Integrated Circuit (RFIC), another Processor, or any suitable combination thereof) may include, for example, a Processor 908 and a Processor 912 that execute the instructions 910. The term “Processor” is intended to include multi-core processors that may comprise two or more independent processors (sometimes referred to as “cores”) that may execute instructions contemporaneously. Although FIG. 9 shows multiple processors 904, the machine 900 may include a single processor with a single core, a single processor with multiple cores (e.g., a multi-core processor), multiple processors with a single core, multiple processors with multiples cores, or any combination thereof.

The memory 906 includes a main memory 914, a static memory 916, and a storage unit 918, both accessible to the processors 904 via the bus 940. The main memory 906, the static memory 916, and storage unit 918 store the instructions 910 embodying any one or more of the methodologies or functions described herein.

The instructions 910 may also reside, wholly or partially, within the main memory 914, within the static memory 916, within machine-readable medium 920 within the storage unit 918, within the processors 904 (e.g., within the processor's cache memory), or any suitable combination thereof, during execution thereof by the machine 900.

The I/O components 902 may include various components to receive input, provide output, produce output, transmit information, exchange information, or capture measurements. The specific I/O components 902 included in a particular machine depend on the type of machine. For example, portable machines such as mobile phones may include a touch input device or other such input mechanisms, while a headless server machine will likely not include such a touch input device. The I/O components 902 may include many other components not shown in FIG. 9. In various examples, the I/O components 902 may include output components 926 and input components 928. The output components 926 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), or other signal generators. The input components 928 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further examples, the I/O components 902 may include biometric components 930, motion components 932, environmental components 934, or position components 936, among a wide array of other components. For example, the biometric components 930 include components to detect expressions (e.g., hand expressions, facial expressions, vocal expressions, body gestures, or eye-tracking), measure biosignals (e.g., blood pressure, heart rate, body temperature, perspiration, or brain waves), or identify a person (e.g., voice identification, retinal identification, facial identification, fingerprint identification, or electroencephalogram-based identification). The motion components 932 include acceleration sensor components (e.g., accelerometer), gravitation sensor components, rotation sensor components (e.g., gyroscope). The environmental components 934 include, for example, one or cameras, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 936 include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 902 further include communication components 938 operable to couple the machine 900 to a network 922 or devices 924 via respective coupling or connections. For example, the communication components 938 may include a network interface Component or another suitable device to interface with the network 922. In further examples, the communication components 938 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 924 may be another machine or any of a wide variety of peripheral devices (e.g., a peripheral device coupled via a USB).

Moreover, the communication components 938 may detect identifiers or include components operable to detect identifiers. For example, the communication components 938 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Data glyph, Maxi Code, PDF417, Ultra Code, UCC RSS-2D bar code, and other optical codes), or acoustic detection components (e.g., microphones to identify tagged audio signals). In addition, a variety of information may be derived via the communication components 938, such as location via Internet Protocol (IP) geolocation, location via Wi-Fi® signal triangulation, or location via detecting an NFC beacon signal that may indicate a particular location.

The various memories (e.g., main memory 914, static memory 916, and/or memory of the processors 904) and/or storage unit 918 may store one or more sets of instructions and data structures (e.g., software) embodying or used by any one or more of the methodologies or functions described herein. These instructions (e.g., the instructions 910), when executed by processors 904, cause various operations to implement the disclosed examples.

The instructions 910 may be transmitted or received over the network 922, using a transmission medium, via a network interface device (e.g., a network interface component included in the communication components 938) and using any one of several well-known transfer protocols (e.g., hypertext transfer protocol (HTTP)). Similarly, the instructions 910 may be transmitted or received using a transmission medium via a coupling (e.g., a peer-to-peer coupling) to the devices 924.

### Glossary

“Carrier signal” refers, for example, to any intangible medium that is capable of storing, encoding, or carrying instructions for execution by the machine and includes digital or analog communications signals or other intangible media to facilitate communication of such instructions. Instructions may be transmitted or received over a network using a transmission medium via a network interface device.

“Client device” refers, for example, to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers, for example, to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers, for example, to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component”(or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” refers, for example, to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Ephemeral message” refers, for example, to a message that is accessible for a time-limited duration. An ephemeral message may be a text, an image, a video and the like. The access time for the ephemeral message may be set by the message sender. Alternatively, the access time may be a default setting or a setting specified by the recipient. Regardless of the setting technique, the message is transitory.

“Machine storage medium” refers, for example, to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”“Non-transitory computer-readable storage medium” refers, for example, to a tangible medium that is capable of storing, encoding, or carrying the instructions for execution by a machine.

“Signal medium” refers, for example, to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

“User device” refers, for example, to a device accessed, controlled or owned by a user and with which the user interacts perform an action or interaction on the user device, including an interaction with other users or computer systems.

What is claimed is:

1. A computer-implemented method comprising:
storing an advertising campaign comprising a set of episodic advertisements, each episodic advertisement comprising a segment of a campaign progression defined by a plurality of the episodic advertisements presented in sequence;
in response to receiving a request for an advertisement to present to a user:
retrieving from the advertising campaign a first episodic advertisement;
causing presentation of the first episodic advertisement to a user device associated with the user; and
receiving a user interaction with the first episodic advertisement; and
in response to receiving a subsequent request for an advertisement to present to the user:
selecting from the advertising campaign a second episodic advertisement, such the selected second episodic advertisement is variable as a function of the user interaction with the first episodic advertisement; and
causing presentation of the second episodic advertisement to the user device.

2. The computer-implemented method of claim 1, further comprising:
maintaining campaign state data specific to the user for the advertising campaign; and
updating the campaign state data for the user based on the user interaction with the first episodic advertisement,
wherein the determining of the second episodic advertisement is based at least in part on the campaign state data.

3. The computer-implemented method of claim 2, wherein selecting the second episodic advertisement comprises:
evaluating episodic advertisements in the advertising campaign to identify a set of candidate advertisements eligible to be presented based on the updated campaign state data; and
selecting the second episodic advertisement from the set of candidate advertisements.

4. The computer-implemented method of claim 3, wherein the set of episodic advertisements provides for predefined sequencing of episodic advertisements in the advertising campaign according to a plurality of different potential sequences, and wherein identification of the set of candidate advertisements is based at least in part on said predefined sequencing.

5. The computer-implemented method of claim 4, wherein at least one of the plurality of potential sequences comprises a plurality of decision points, each decision point comprising a respective episodic advertisement which prompts a user interaction that affect selection of one or more subsequent advertisements in the respective sequence, wherein selection of each episodic advertisement in the predefined sequence comprises:
based on the campaign state data, identifying respective identities of a subset of episodic advertisements previously presented to the user in the advertising campaign; and
wherein the identifying of each respective episodic advertisement as candidate advertisement is at least in part conditional upon the subset of previously presented episodic advertisements satisfies selection criteria of said predefined sequencing.

6. The computer-implemented method of claim 1, wherein the first episodic advertisement provides a choice between alternative options to the user, the user interaction with the first episodic advertisement comprising a selection by the user of one of the alternative options,
wherein the campaign progression experienced by the user via subsequent episodic advertisements is variable dependent on the selected option.

7. The computer-implemented method of claim 2, further comprising generating the set of episodic advertisements using a template system.

8. The computer-implemented method of claim 7, wherein generating the set of episodic advertisements using the template system comprises:
defining advertisement templates, each advertisement template comprising:
one or more variables representing recipients of data bindings at runtime; and
one or more presentation components defining content for presentation;
selecting, for each episodic advertisement, an advertisement template; and
binding the variables of the selected advertisement template based at least in part on user-specific data.

9. The computer-implemented method of claim 8, wherein binding the variables of the selected advertisement template comprises selecting data bindings for the variables based on current campaign state data for the user.

10. The computer-implemented method of claim 7, wherein the template system comprises storylets, each of which comprises a narrative segment with one or more decision points, each decision point offering a set of choices to the user that influence subsequent narrative segments.

11. The computer-implemented method of claim 1, further comprising:
providing a recap of one or more previously presented episodic advertisements provided to the user in the advertising campaign.

12. The computer-implemented method of claim 11, wherein providing the recap comprises:
automatically selecting content from one or more previously presented episodic advertisements in the campaign; and
autonomously composing the recap based at least in part on the selected content from the one or more previously presented episodic ads.

13. The computer-implemented method of claim 1, wherein the episodic advertisements comprise interactive content related to a computer-implemented game, the interactive content permitting user interaction with a game world specific to the game.

14. The computer-implemented method of claim 13, further comprising:
maintaining campaign state data that indicates or permits reconstruction of a current game state specific to the user based on interactions with respective episodic advertisements;
in response to receiving a user interaction with a respective episodic advertisement by the user, accessing a current game state for the user within the advertising campaign; and
presenting the respective episodic as set within an instance of the game world consistent with the current game state for the user.

15. The computer-implemented method of claim 14, wherein the interactive content is generated using in-game assets of the game.

16. The computer-implemented method of claim 15, wherein the in-game assets comprise at least one of:
computer-generated imagery associated with the game;
audio content associated with the game;
textual content associated with the game;
video content associated with the game;
character models associated with the game;
scene models associated with the game; or
game world models associated with the game.

17. The computer-implemented method of claim 14, wherein campaign progression provided by presentation in sequence of a plurality of the episodic advertisements represents a narrative arc set in the game world.

18. The computer-implemented method of claim 14, wherein the episodic advertisements comprise playable advertisements allowing a limited portion of gameplay based on a game state, user interaction with respective episodic advertisement resulting in updating of game state of the user.

19. The computer-implemented method of claim 18, wherein the limited portion of gameplay comprising an interactive scene associated with the game, the respective scene of each episodic advertisement comprising episodic story content set in the game world.

20. The computer-implemented method of claim 18, wherein:
the game state includes a world state indicating a state of the game world, and
wherein interaction with one or more of the episodic advertisements of the campaign allows the user to influence the world state persistently, such that world state changes caused by user interaction with one episodic advertisement persists in representation of the game world in subsequent episodic ads in the campaign.

21. The computer-implemented method of claim 20, further comprising:
upon detecting installation by the user of the game advertised via the advertising campaign, transferring the current world state associated with the advertising campaign to a game instance rendered by the installed game; and
providing further gameplay via the installed game based on the transferred world state, such that said further gameplay reflects outcomes of the user interactions made during the episodic advertising campaign.

22. The computer-implemented method of claim 20, further comprising:
responsive to detecting user engagement for initiating direct play via a game instance outside of the episodic advertising campaign, synchronizing the current game state for the user from the advertising campaign with said game instance, such that the user's progression in the episodic advertising campaign is reflected in at least one of a game narrative and available in-game assets of said game instance.

23. The computer-implemented method of claim 22, wherein the synchronized game state includes at least one of:
in-game assets acquired by the user during interaction with the episodic advertisements;
character development states influenced by user choices within the episodic advertisements; and
narrative progression points reached by the user within the episodic ad campaign.

24. The computer-implemented method of claim 22, further comprising:
upon initiating said game instance, providing the user with an option to import the current game state into said game instance, synchronization of the game state being conditional and responsive to user selection of said option.

25. A system for delivering an advertising campaign comprising a set of episodic advertisements, the system comprising:
one or more computer processor devices;
a memory device storing an advertising campaign comprising a set of episodic advertisements, each episodic advertisement comprising a segment of a campaign progression defined by a plurality of the episodic advertisements presented in sequence; and
memory on which is stored instructions that, when executed by the one or more computer processor devices, configure the system to perform operations comprising:
in response to receiving a request for an advertisement to present to a user:
retrieving a from the advertising campaign a first episodic advertisement;
causing presentation of the first episodic advertisement to a user device associated with the user; and
receiving a user interaction with the first episodic advertisement; and
in response to receiving a subsequent request for an advertisement to present to the user:
selecting from the advertising campaign a second episodic advertisement, such the selected second episodic advertisement is variable as a function of the user interaction with the first episodic advertisement; and
causing presentation of the second episodic advertisement to the user device.

26. A non-transitory computer-readable storage device on which is stored instructions to configure one or more computer processor devices, when executing the instructions, to perform operations comprising:
storing an advertising campaign comprising a set of episodic advertisements, each episodic advertisement comprising a segment of a campaign progression defined by a plurality of the episodic advertisements presented in sequence;
in response to receiving a request for an advertisement to present to a user:
retrieving a from the advertising campaign a first episodic advertisement;
causing presentation of the first episodic advertisement to a user device associated with the user; and
receiving a user interaction with the first episodic advertisement; and
in response to receiving a subsequent request for an advertisement to present to the user:
selecting from the advertising campaign a second episodic advertisement, such the selected second episodic advertisement is variable as a function of the user interaction with the first episodic advertisement; and
causing presentation of the second episodic advertisement to the user device.
